(19) United States
(12) Patent Application Publication
(10) Pub. No.: US 2006/0178949 A1
(43) Pub. Date: Aug. 10, 2006

(54) Integrated system and method for inducing, brokering and managing alternative transportation modes for commuters and generating commute statistics

(76) Inventor: Paul Thomas McGrath, Santa Cruz, CA (US)

Correspondence Address: MICHAEL A. GUTH, 2-2905 EAST CLIFF DRIVE, SANTA CRUZ, CA, 95062, US

(21) Appl. No.: 11/348,809

(22) Filed: Feb. 6, 2006

Related U.S. Application Data
(60) Provisional application No. 60/650,845, filed on Feb. 7, 2005.

(51) Int. Cl. G06Q 30/00

(52) U.S. Cl. 705/26

(57) ABSTRACT

A system is provided for brokering commuter transactions initiated by individuals grouped by association and for populating individual commutes schedules and tallying incentive points earned by those individuals. The system includes a network server and data repository connected to a data network, the server including software for providing services to groups of individuals, and a plurality of network nodes having access to the network, the nodes operated by respective individuals of each group for the purpose of offering rides and for searching rides.

### CROSS-REFERENCE TO RELATED APPLICATIONS

The present application claims priority to provisional patent application 60/650,845, filed on Feb. 7, 2005.

### BACKGROUND

1. Field of the Invention

The present invention is in the field of network communication including software enabling such and pertains particularly to a system and method for inducing, brokering, and managing alternative forms of transportation for employees or other persons with relation to workplace or worksite commuting and generating commute statistics

2. Description of Related Art

The field of transportation relating to the general populous in commuting to and from work, for example, includes several alternate modes that are encouraged by public entities as desirable in a community or region over single occupant vehicle commuting. These transportation modes include car-pooling or ride sharing, public transit systems like trolley, bus, and train systems, among others. In all areas, walking and bicycling are also encouraged.

There are incentives and public facilities in place to promote mass transit over single occupant vehicle commuting for the purpose of easing congestion on roadways; reducing smog or pollutants emitted into the atmosphere; and to aid in future transportation planning and roadway construction requirements.

Carpool lanes are available in some urban areas. The same is true with bus systems and train systems.

Incentives for using alternative transportation may include faster commute time using car pool lanes (ride sharing), lower cost of transportation using a bus or train system, and flexible worker start times for those using bicycles, those who walk, or those using a combination of alternative transportation modes. Other significant advantages are sharing the chore of driving, sharing the cost of car commuting, and providing healthier ways of getting to work with walking, biking, etc.

A problem with the state of the art as it exists is that many alternative transportation schemes are ad-hoc, not well planned, or require too much effort on the part of the commuter to manage. Bus systems and train systems may be over crowded in some areas, and may suffer from low rider ship in other areas. Often carpool lanes may become just as congested as single occupant vehicle lanes.

Another problem with the state of the art is that it is difficult to find carpool partners and the ride-share systems that are in place do not offer the convenience and flexibility that the commuter desires, with regards to carpooling.

Moreover, desire to streamline commuting has been more a public entity concern than one of a corporate or private entity concern.

Some public regions and even specific work places are known to actively encourage ride sharing and some other forms of alternative transportation modes for their workers as a policy. However, implementing such policies may be based solely upon volunteer participation, and without good management and oversight, many ad-hoc policies fall short of achieving their goals. Likewise there are no company specific solutions known to the inventor that are simple to use, provide active incentives for using any or all modes of alternate transportation, or that provide brokering services, and that generate useable statistics or tracking of alternate transportation leveraged for management purposes.

What is clearly needed is a network-based system and method for inducing, brokering, and managing participation in the practice of using alternative forms of commute transportation other than single occupant commuting by vehicle for commuters to and from one or more worksites.

### SUMMARY

A system is provided for brokering commuter transactions initiated by individuals grouped by association and for populating individual commutes schedules and tallying incentive points earned by those individuals. The system includes a network server and data repository connected to a data network, the server including software for providing services to groups of individuals, a network node having connection to the network and having access to the server, the node including software for configuring services offered, at least one network node having access to the network and associated to each group of individuals, the node including software for registering and administering local parameters of at least one group of individuals; and a plurality of network nodes having access to the network, the nodes operated by respective individuals of each group for the purpose of offering rides and for searching rides, and for claiming credit for taking any type of alternative commute such as biking or walking to work.

In some embodiments the network is the Internet network. In some embodiments, the server is a web server. In some embodiments, the individuals are employees, groups of which define those employees of a company or business. In some embodiments, the individuals are students, groups of which define students attending a university campus. In some embodiments using the Internet, the services are web services define by web service description language. In this embodiment, web services include ride publishing, ride searching, transaction brokering, schedule population, statistics generation, and point tallying. In some embodiments, the local parameters of individuals include contact information and worksite location.

According to another aspect of the present invention a software suite for brokering commuter transactions initiated by individuals grouped by association and for populating of individual commute schedules and tallying incentive points earned by those individuals. The software suite includes a first portion thereof for providing services to the individuals, a second portion thereof for enabling definition and creation of those services; and a third portion thereof for registering groups and for managing local parameters of groups registered.

In some embodiments, the software suite is practiced on the Internet network and on a sub-network connected to the Internet network. In some embodiments, commuter transactions include acceptance and confirmation of a ride request submitted in response to an offered ride, the acceptance thereof a function of the software. In some embodiments, commuter transactions include acceptance and confirmation of a ride request submitted in response to an offered ride, the acceptance thereof a function of the individual offering the ride.

In some embodiments, the individual commute schedules are automatically populated as a direct result of transactions recorded by the software. Also, the incentive points are exchangeable for one or a combination of cash and discounts on third-party offered services or products. In some embodiments the incentives are prize-based. They are not exchanged. Each incentive point provides a chance of winning prizes, the same as a raffle ticket system. Each incentive point is equivalent to one “raffle ticket”. Points being exchanged for goods can be included as an alternative embodiment, or both incentive schemes could be run concurrently.

In some embodiments, the first portion thereof has runtime access to one or more employee databases for the purpose of synchronization of data updated to those databases with the network database.

According to another aspect of the invention in a system for brokering commuter transactions over a network, a method is provided for completing a commuter transaction including steps for (a) searching for a published ride offer; (b) selecting an available ride offer; (c) sending a ride request; (d) accepting the submitted request; and (e) confirmation acceptance of the request. In one aspect, in step (a), the published ride offer is one of several offers returned as search results. In this aspect, in step (b), the selected offer most closely matches the search criteria. In one aspect, in step (a), the search criteria includes day or days the ride is needed, geographic origin of the requester, desired arrival and departure times, and destination of the ride.

### BRIEF DESCRIPTION OF THE DRAWING FIGURES

FIG. 1 is an architectural overview of a network-based system for brokering ride sharing according to some embodiments of the present invention.

FIG. 2 is a block diagram illustrating basic components of the web interface of FIG. 1 according to some embodiments of the present invention.

FIG. 3 is a block diagram illustrating web service configuration software of FIG. 1 according to some embodiments of the present invention.

FIG. 4 is an exemplary screen of the web interface of FIG. 1 illustrating commuter log in.

FIG. 5 is an exemplary screen invoked through interaction with the new user register option of FIG. 4.

FIG. 6 is an exemplary screen illustrating a publish ride configuration window according to some embodiments of the present invention.

FIG. 7 is an exemplary screen illustrating a next phase of publishing a ride according to some embodiments of the invention.

FIG. 8 is an exemplary screen illustrating a ride search interface according to some embodiments of the present invention.

FIG. 9 is an exemplary screen listing available rides returned as a result of a search for available rides configured and submitted to the system.

FIG. 10 is an exemplary screen illustrating ride details expanded from a results list of rides according to some embodiments of the present invention.

FIG. 11 is an exemplary request form for confirming the intended request data for the potential rider.

FIG. 12 is a plan view of a generated ride request message received at the station of the driver according to some embodiments of the present invention.

FIG. 13 is a plan view of a message illustrating that the request of message 1200 has been accepted without edit.

FIG. 14 is an exemplary screen illustrating an interface for a user profile.

FIG. 15 is an exemplary screen illustrating record of alternate commute (AC) points tallied as a user participates with the system of the invention.

FIG. 16 is an exemplary screen illustrating system generated statistical reports according to some embodiment of the present invention.

FIG. 17 is an exemplary screen of the WC software of Fig. illustrating an ETC interface for configuring a company account according to some embodiments of the present invention.

FIG. 18 is a block diagram illustrating cooperation of multiple business services as a single entity according to some embodiments of the present invention.

FIG. 19A is a screen shot of a sign in page according to some embodiments of the present invention.

FIG. 19B is a screen shot of a page after sign in according to some embodiments of the present invention.

FIG. 20 is a screen shot of an account set-up page according to some embodiments of the present invention.

FIGS. 21A-B are screen shots of a ride offer page according to some embodiments of the present invention.

FIG. 22 is a screen shot of a find a ride page according to some embodiments of the present invention.

FIG. 23 is a screen shot of a ride search results page according to some embodiments of the present invention.

FIG. 24 is a screen shot of a ride details page according to some embodiments of the present invention.

FIG. 25 is a screen shot of a ride request window according to some embodiments of the present invention.

FIG. 25A is a screen shot of an email generated according to some embodiments of the present invention.

FIG. 26 is a screen shot of a ride request received window according to some embodiments of the present invention.

FIG. 27 is a screen shot of an accept ride request window according to some embodiments of the present invention.

FIG. 28 is a screen shot of a deny ride request window according to some embodiments of the present invention.

FIG. 29 is a screen shot of a ride request response window according to some embodiments of the present invention.

FIG. 30 is a screen shot of an email generated according to some embodiments of the present invention.

FIG. 31 is a screen shot of an email generated according to some embodiments of the present invention.

FIG. 32 is a screen shot of a myProfile window according to some embodiments of the present invention.

FIGS. 33A-B are the upper and lower portions of a claim acPoints window according to some embodiments of the present invention.

FIG. 34 is a screen shot of a commute savings window according to some embodiments of the present invention.

FIGS. 35A-B are the upper and lower portions of a statistics window according to some embodiments of the present invention.

FIGS. 36A-B are the upper and lower portions of an ETC window according to some embodiments of the present invention.

FIGS. 37A-B are the upper and lower portions of an Incentives window according to some embodiments of the present invention.

### DETAILED DESCRIPTION

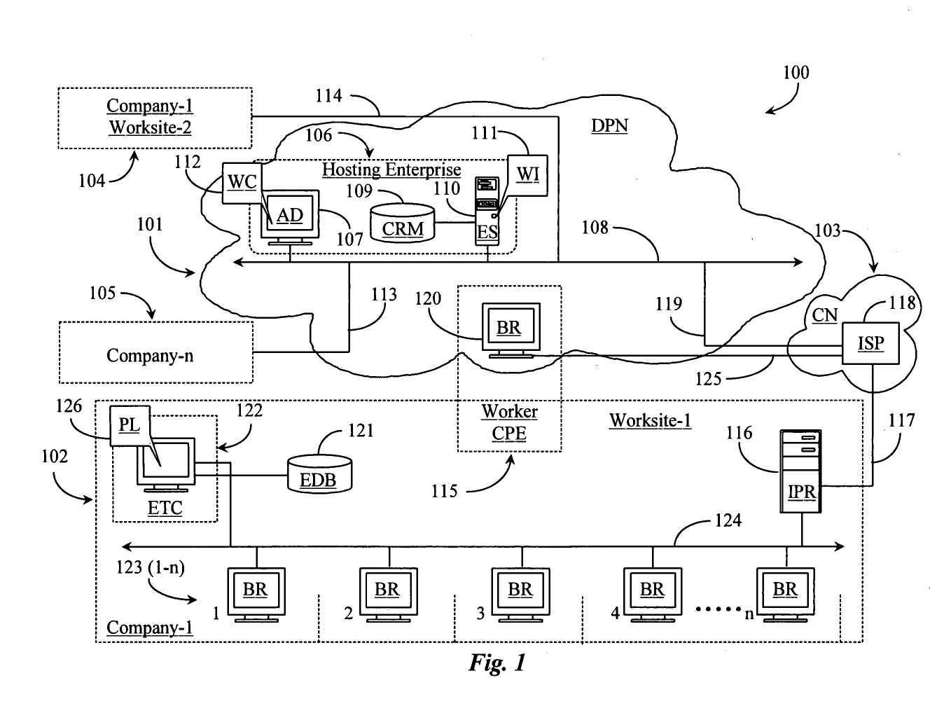

FIG. 1 is an architectural overview 100 of a network-based system for brokering ride sharing according to an embodiment of the present invention. Overview 100 encompasses an integrated communications network and software enabled system of hardware for practicing the present invention. A host data packet network (DPN) 101 is illustrated and more particularly illustrated by a DPN backbone 108 extending there through that may represent all of the equipment, access points, and lines that make up the network as a whole. In one embodiment, network 101 supported by backbone 108 is the Internet network including the World Wide Web (WWW). In this embodiment, there are no geographic limitations to the practice of the present invention. In another embodiment, DPN 101 may be a corporate wide-area-network (WAN), or a wirelessly accessed municipal area network (MAN) without departing from the spirit and scope of the present invention.

DPN 101 includes a hosting enterprise 106 within its domain, that is to say that hosting enterprise 106 may, from one or more specific addresses relevant to the domain of network 101, offer services accessible through making network connection to DPN 101 from other disparate carrier networks and sub-networks. Hosting enterprise 106 may be any enterprise authorized according to the spirit of the present invention to provide support and service to outside parties to practice an integrated form of carpooling including facilitation of tracking alternate forms of commute other than carpooling or vanpooling.

Host enterprise 106 leverages at least one enterprise server node (ES) 110 for the purpose of enabling a customer base access to and interaction ability with the services of the present invention. Enterprise server 110 has a software interface or Web interface (WI) 111 provided thereto and executable therein to perform various tasks related to the brokering and management of rideshare and alternate commuting methods that may be undertaken by customers or users of the system. ES 110 is connected to backbone 108 in this example to logically illustrate accessibility on the network.

A customer relations database (CRM) 109 is provided and has data exchange connection capability with ES 110. In this embodiment, CRM 109 is connected to ES 110 via a separate data link other than an Internet or DPN communications link. However, in some embodiments, ES 110 may access CRM 109 over the network rather than by direct data linking. CRM 109 is adapted to contain, according to various embodiments, data about customers of enterprise 106 and about the subsequent activities of those customers pertinent to use of the present invention. For example, client business data, employee data, employer incentive data, and use statistics data may all be contained in and made accessible from CRM 109 in the course of practicing the present invention. CRM 109 may be an optical data storage facility, or any other type of data where housing facility including both network hosted or internal to a host system such as ES 110 for example. There are many possible alternatives. It is presumed that data held in CRM 109 is confidential and therefore may be kept in some encrypted state except for presentation to authorized entities.

Host 106 includes an administrative node (AD) 107 within its domain in this example. AD 107 is illustrated similarly as ES 110 in that it is connected for communication over the network to backbone 108. AD 107 is not required to be included within a physical or network domain of enterprise 106. AD 107 may be a remote node that is authorized to access ES 110 from any other domain including sub-networks that have access to network 101 and subsequently to ES 110 over backbone 108. AD node 107 is adapted as a workstation or other graphical user interface (GUI) based computing node through operation of which enables administrative access to other systems of enterprise 106 including ES 110. A web services configuration (WC) application 112 is provided to AD node 107 and adapted to facilitate an operator writing services and otherwise performing administrative tasks with respect to ES 110. In this regard, WC 112 and WI 111 cooperate and communicate for the purpose of enabling the invention with respect to practice of the invention.

A company 102 (company-1) is illustrated in this example and represents a portion of architecture 100 including company employee stations arranged within a physical worksite (worksite-1). Company 102 has a local area network (LAN) 124 installed therein and adapted as a local communications network that has access to network 101. LAN 124 may be an Ethernet, or other type of local network as long as the protocols of DPN 100 are supported to the extent communication is possible.

A plurality of computer workstations or nodes 123 (1−n) is provided within company worksite 102 and supported for communication with each other over LAN 124 and, additionally, enhanced for communication with one or more outside networks like DPN 101 via individual network-capable browser applications (BR) installed. An Internet protocol router (IPR) 116 is similarly provided and connected to LAN 124 and serves as a gateway to network 101 for any connected node 123 (1−n). IPR 116, in this case connects to DPN 101 through an Internet Service Provider (ISP) 118 located in a carrier network (CN) 103, which may be a public-switched-telephone-network (PSTN), for example. In an embodiment wherein DPN 101 is the Internet network, ISP may be accessed through digital services link (DSL), integrated services digital network (ISDN), or other high-speed network connection. IPR 116 connects to ISP 118 via a link 117 and from ISP 118 connection is made to backbone 108 via a network access line 119.

Any operator employing any of workstations 123 (1-n) may go “online” to network 101 using the illustrated connective architecture including IPR 116, ISP 118, and path 117 and 119 to backbone 108 and may communicate with and interact with services configured by WC 112 and hosted in ES 110, of which are more particularly accessible through WI 111. In one embodiment of the present invention, no software components or downloads are required in any of stations 123 (1−n) in order to practice the present invention. That is to say that services may be entirely network-based and accessible through normal browser functions known in the art.

Company 102 has an employee transportation coordinator (ETC) facility 122 provided there in as, in this example, a special administration node, and connected to LAN 124 for communication. ETC 122 encompasses, in one embodiment, any workstation that may be designated for the purpose of facilitating coordination and management of employee activities relevant to use of the system of the invention. An ETC operator may be, for example, a designated individual from human resources, an employee supervisor, and employee manager, or any other trusted user. ETC station 122, in this embodiment, a computer having a GUI capability, has access to an employee database facility 121, in this case via direct data link. EDB 121 is adapted to contain all of the pertinent data about all of the employees working for company 102 that may report to worksite-1. This data may include but is not limited to full name, home address, telephone, email, and other contact data. Likewise, job description, regular work schedule hours, vacation schedule and workplace assignment information may also be a part of EDB 121. EDB 121 may further contain confidential employee files and the like as well however, for the purpose of the present invention, ETC 122 may only have access to or be authorized to access certain information useful in practicing rideshare according to aspects of the present invention.

WI 111 may have suitable log in security regimens for regular employees such as those accessing through stations 123 (1−n) and for an ETC analogous to ETC 122. However, in this case, ETC 126 is enabled with a software plug in component (PL) 126 that enables certain transactions to occur automatically between EDB 121 and CRM 109, such transaction further enabled during practice of the invention in which certain web-based services (described later) may be invoked.

In this example, practice of the present invention relative to the physical location of company workers 123 (1−n) is not limited. According to one embodiment, workers may also access ES 110 and WI 111 and register to practice the invention from any remote location using suitable network-capable utilities like a computer, laptop, or even a cellular telephone. In this example, worker customer premise equipment (CPE) 115 is illustrated including a computer station 120. CPE 115 is physically remote from company 102, worksite-1, but is illustrated as an overlapping rectangle only to show some association to the worksite. In this case, station 120 has a separate connection to ISP 118 via an access line 125, which may be any digital services connection line. Worker 115 may utilize services offered from the point of access of ES 110 in concert with any other company workers associated with company 102 without regard to physical location of such workers as no resident software components are required in order to practice the present invention, only network navigation capabilities are required such as through use of a network browser application. OK

Another worksite that may be associated with company 102 is worksite 104 or company-1 worksite-2. Like worksite-1, worksite-2 (104) may have resident workers operating from a LAN and a separate ETC analogous to ETC 122 including a separate EDB analogous to EDB 121. Likewise, ETC 122 may be responsible for the workers resident at worksite 104 and EDB 121 may contain their information without departing from the spirit and scope of the present invention. There are many possibilities.

Assuming, for the purpose of discussion that worksite-2 of company-1 (104) has an independent ETC and EDB, then the ETC for that worksite may connect to the prevailing network through network access line 114 through a suitable carrier network whereby the ETC for that site may set-up the service for the workers of that site to use.

A company 105 (company-n) is illustrated as a company site, which may be analogous is architecture as described with reference to company 102. Company 105 may also be a client of hosting enterprise 106 in the same light as company 102. That is to say that enterprise 106 including WI 111, ES 110 and CRM 109 may be adapted to service many separate groups, for example companies whose employees can access the service securely through log in and authorization mechanisms known in the art to be used for web service access. The services provided to a first company 102 may be provided through a separate home page access, in the case of internet use, than the services provided to a second company 105, which may have its services provided through a different separate home page access. The group of users associated with a first company 102 and the group of users associated with a second company 105 may have their services and data sequestered into separate areas within the CRM 109. Thus, the host 106 is able to provide like services essentially in parallel to a plurality of companies via independent access home pages (in the case of the internet), wherein the users associated with that group are limited to interactions with other users associated with that group.

Administration node 107 aided by WC 112 may be used to configure web services for use by companies for their employees including maintaining and modifying or editing those services when appropriate. Likewise, it is possible to manage several companies' services in a cooperative fashion using WC 112. PL 126 running on ETC station 122 is adapted to enable the ETC to manage tasks at the worksite level for their employees. More detail about the software of the present invention is provided further below.

Using the methods and apparatus of the invention, an incentive-based service for promoting and managing alternate forms of commute may be provided in a way that enhances current capabilities of ride share services. One such enhancement is that the service may broker the connections made for requesting rides and for offering rides and further, may be used to manage or schedule the activity in such a way that is convenient for the user to quickly access a full schedule of commuting obligations. The schedule may also serve as an interface for making modifications, cancellations, or other edits that may be automatically replicated to the appropriate data locations and rendered available for view or pushed using a publish and subscribe model to the correct users to which information may be relevant.

Another enhancement that may be realized practicing the present invention is a capability of an ETC to quickly synchronize pertinent and new information from an EDB like EDB 121, for example, to a CRM system like CRM 109. This enhancement is useful when information changes pertinent to a subscribing commuter changes with respect to work schedule, worksite assignment, and other parameters, which may ultimately play on the commute schedule of that user. Likewise, the ETC may quickly institute important changes like removing an ex-employee from the system or adding a new employee into the system, although typically users add themselves to the system.

In one embodiment, ES 110 aided by WI 111 may be authorized to use one or more EDBs like EDB 121 as data sources when performing tasks, for example, validating commuter eligibility for incentive-based rewards for using the system. One with skill in the art will appreciate that integration of EDB access with respect to task performance at the network level enables many services not available in standard posting board ride share systems.

Yet another enhancement over existing systems is provided by enabling the ability to process data relevant to multiple users' activity with the system and to make that data available through a series of specialized reports, which may be customized at the level of user, company, or at the level of the hosting enterprise.

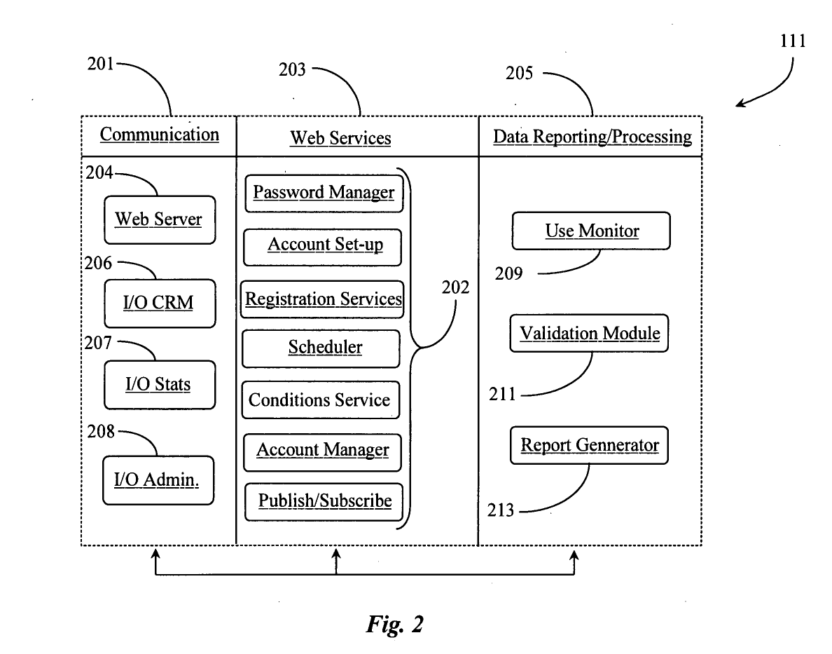

FIG. 2 is a block diagram illustrating basic components of web interface 111 of FIG. 1 according to an embodiment of the present invention. WI 111 may be provided in a configuration of just 3 basic software layers. A software layer 201 is provided within WI application 111 and is adapted as a communication layer. Communication layer 201 includes a web server 204 adapted to serve electronic information over the prevailing network to commuters, enterprise transportation coordinators, and to host administrators, including any authorized third parties providing co-branded services through the interface. There are many standard Web server packages that may be used without departing from the spirit and scope of the present invention. In this regard, web server 204 also enables certain data sync capabilities for commuters (schedule changes, etc.) and for ETCs where the system may push or subscribe to EDB data for syncing with CRM data to help insure that all CRM data is current and correct in the system.

Communication layer 201 includes an input/output (I/O) port software for enabling service access to a customer relations management data facility like CRM 109 of FIG. 1. Communication layer 201 has an I/O port 207 adapted to enable system service access to current statistics processed by the system relevant to usage. In this regard, important statistics may be subscribed to by any ETC or administrator and may be presented in customized manner, for example, average vehicle ridership (AVR) for a worksite or company

Communication layer 201 has an I/O port 208 adapted to provide direct administrative input/output capabilities through an administrative interface for management of the system and services using, if desired, a network (LAN, etc.) other than the service network or Internet. In one embodiment, all communication and management undertaken with respect to the system by ETC and administrative operators may be conducted through the service network using the web server and secure interfaces (PL 126) and (WC 112). However that is not required in order to practice the present invention as a separate data link may be established directly between an administrative node like node 107 of FIG. 1 and ES 110 for dedicated service and management.

WI application 111 has a web services layer 203 provided therein and adapted to provide all of the web service configuration tools and description language (WSDL) to define and configure useful web services for leverage by commuters, coordinators, management, and third parties authorized to access the system. Layer 203 includes a plurality of defined web services 202, which may be considered basic services in practicing the invention but which do not constitute any limitations as to what services may be included or conceived.

Reading from top to bottom in services 202, a password management service is provided to accept and validate authorization data from commuters, employee transportation coordinators, host administrators, and any authorized third parties. An account set-up service is provided within the scope of services 202 and is adapted to enable host administrators and enterprise traffic coordinators to configure and set up new accounts as well as to enable them to make important changes to account configurations already in the system.

A registration services interface and application is provided within the scope of web services 202, and is adapted to enable commuters to register, activate, and begin using the service. A scheduler module (software) is provided within the scope of service 202, and is adapted to enable scheduling with regard to account setup and notification sent out to commuters and to provide scheduling services with respect to communication from the host administrator to the traffic coordinator and from the traffic coordinator to commuters. The scheduler module may also be used to manage commuter schedules.

In one embodiment, services 202 includes a conditions reporting service, which may be internally provided or which may be provided by a third party to include optional information into the service for publishing to commuters for example. Current traffic conditions, road closures, route diversions, California highway patrol activities (published), weather conditions, and accident reports may be published to commuters or commuters may subscribe to certain ones of those categories.

An account management application is provided within the scope of services 202 and is adapted to provide a host administrator access to the system through web configuration application (112) whether the prevailing service network is used or not. It is important to note herein that a publish in subscribe service module is provided within service layer 203 and is adapted to enable the publishing and subscribing activities with respect to appropriate services offered.

WI application 111 has a data reporting and processing layer 205 adapted as an intelligent arm of the system for calculating usage statistics and making reporting possible within the system. Layer 205 has a usage monitor 209 that collects data from the actual use of the system including any relevant information entered by commuters during that use, like indication for example, of alternate forms of commuting adopted by commuters over their commute schedules. Monitor 209 may include monitoring of all server traffic and use statistics with respect to any client activity occurring within the enterprise server.

A validation module 211 is provided within layer 205 and provides a component for validating commuter activity with respect to earning and claiming alternate commuter points for use in acquiring incentive-based prizes Validation module 211 may also be used in other types of validation tasks like validating the existence or record of a commuter. A report generator 213 is provided within layer 205 and is adapted to generate customizable reports regarding isolated activity and general activity with respect to commuting. Layers 201, 203, and 205 cooperate with each other in accomplishing the various tasks of the system.

OK

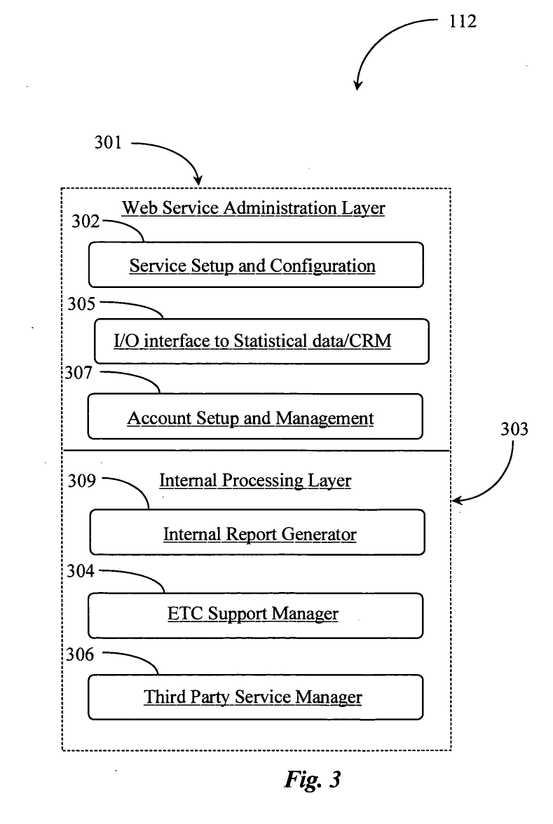

FIG. 3 is a block diagram illustrating web service configuration software of FIG. 1 according to an embodiment of the present invention. WC 112 has 2 basic software layers as a client to application 111. A web service administration layer (WSAL) 301 is provided as part of software 112 and is adapted to provide the appropriate application program interface (API) capabilities including an API for service setup and configuration API 302. An administrator may use any appropriate web tools and applications for defining and setting up web services and configuring them to run properly. API 302 may support web and service building components and software like known desktop publishing applications, including database access support.

An I/O interface API 305 provides extension of WC use to host-domain data pools or database applications like CRM. An account setup API 307 provides extension of the system to administrative spreadsheet processing applications like Excel™, for example, that may be resident on an administrator's desktop. API 307 may also provide extension to the companies payment system if automated. Layer 301 has all of the necessary components to provide robust web administration, moderation, and maintenance duties that may be required.

WC 112 has an internal processing layer 303, adapted to enable some off-system processing of raw data in one embodiment. For example, an internal report generator 309 enables an administrator to generate topical and customized reports for internal use in determining overall traffic and other pertinent states that may affect the service as a whole in light of multiple clients.

Layer 303 includes an ETC support manager interface 304 adapted to allow a host administrator to communicate with and support any ETC of any registered client. Such support may include but is not limited to sharing of third party and internally generated statistics and reports. Support in registering new worksites, support in consolidating worksites between multiple co-located facilities, and the like may be provided through ETC support manager 304.

Internal processing layer 303 may also include a third party service manager Interface 306. Interface 306 may be adapted to provide set up management and control over introduction of any third-party-sourced information services or functional service that may ultimately be offered to commuters who subscribe to the system. Therefore, in addition to company incentive programs that may provide rewards for commuter participation, additional rewards, discounts, benefits, and the like may be offered through, for example, third-party advertising. One example might be that commuters who have earned a certain number of points for using any alternate form of transportation other than single occupant vehicle (SOV) may enjoy discounts at participating third-party retail locations or service locations. By providing a fully integrated system capable of brokering commute offers and requests, and the capability of tracking usage, commuters can be validated or certified according to number of points earned for any given period. Likewise, through interface 306, a mechanism could be provided for tracking the number of points used as barter to receive those rewards from third party providers.

Third-party information services may include weather service information, restaurant location and menu information, traffic conditions, links to more regional ride share posting boards, and so on. Any conceived or existing network-based service or advertisement may be provided and tracked statistically through interface 306.

Referring now back to FIG. 1, data communications between third party systems and ES 110 may provide for points usage statistics to be calculated and stored in CRM 109, which may ultimately be summed with recently earned points, the correct balance figures synced back to EDBs of respective company worksites. Likewise, commuters may store this information on their cellular telephones or other mobile computing devices so that they may approach a third-party retail or service outlet and use the points to pay for services rendered, products purchased, or consumables purchased.

One with skill in the art of network hosted or based ride share services will appreciate that minimizing the actual work and scheduling a commuter has to perform is key to inducing that consumer to participate in the program. Integrating separate data systems used in the practice of the invention, such as employee databases, host databases, and third-party databases, provides a backend capability that may be leveraged to perform many tasks that would otherwise be left to the commuter to perform. Such leveraged data systems are leveraged in a manner as to only provide access to data that is pertinent to the activity of commuting and commuters may control, for example, the availability of physical address information, contact information and the like for personal security reasons. For example, a woman requesting a ride would not have to divulge her home address or telephone number or any other personal data. The only information required would be the cross street location for the driver to pick up and drop off any commuter.

In some embodiments of the present invention it is the driver that provides cross street location information. This communicates to potential passengers the general home location of the driver. For most situations drivers pick up and drop off passengers at passengers homes. Therefore passengers are asked for their home location. They may put in their full address if they do want to be picked up from their home. However they do not have to. In some embodiments the drivers email address will be available to the potential passenger. Therefore the potential passenger can contact the driver directly via email—they do not have to send their request through the system. The drivers may, or may not have, also provided a telephone number for the potential passenger to contact them directly.

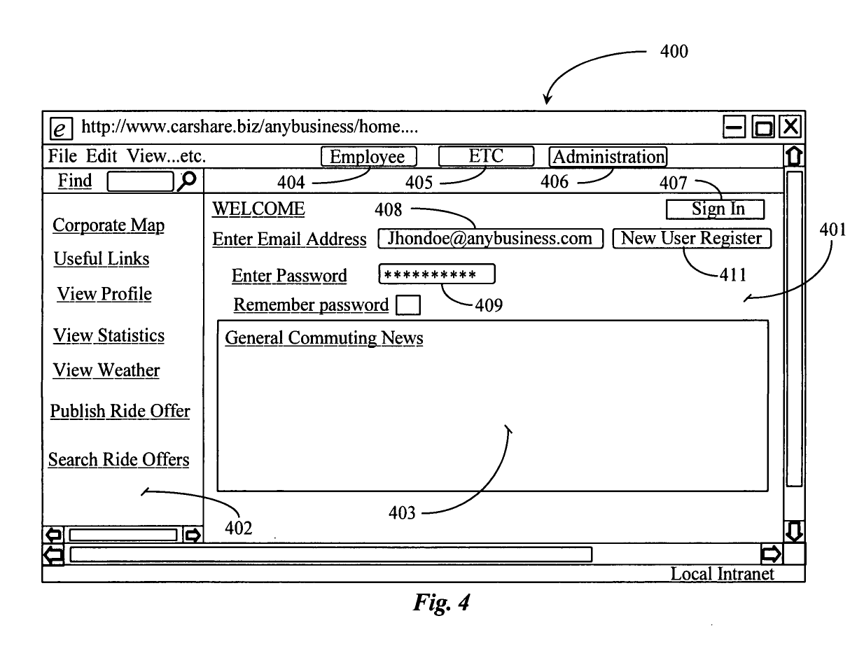

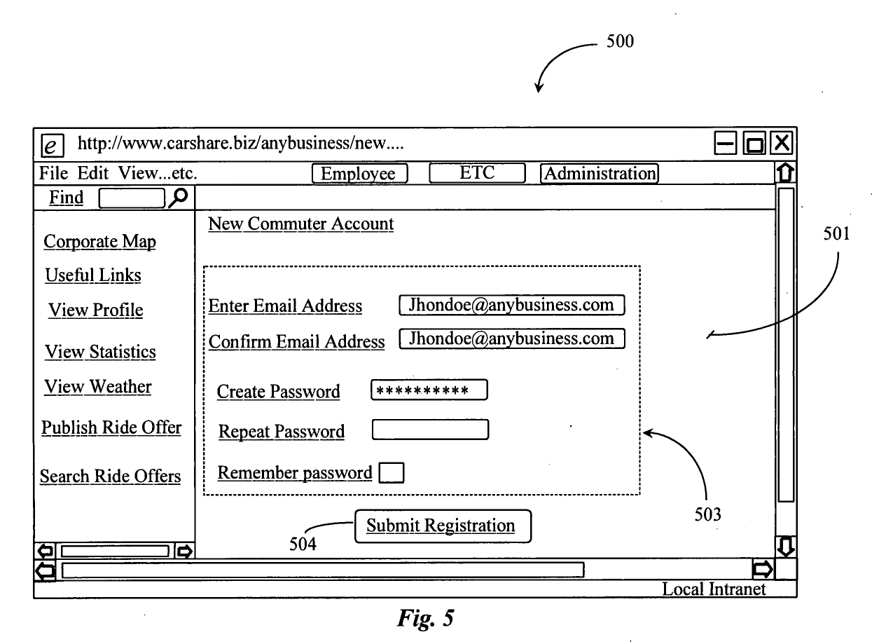

FIG. 4 is an exemplary screen 400 of WI 111 of FIG. 1 illustrating commuter log in. In some embodiments, the system is browser-based in terms of commuter access to the interface. Therefore, screen 400 in this embodiment is presented as a hypertext markup language (HTML) document or web page formatted for a standard web browser. Other web-based communication protocols may also be employed such as wireless application protocol (WAP) and a host of other extension protocols used for various device displays, most of which are known to and are available to the inventor.

In some embodiments, the commuter log in screen 400 is specific to a group of users. For example, the URL http://www.carshare.biz/anybusiness/home is a home page dedicated to the group of user-commuters associated with the group “anybusiness”. User-commuters from a different group of users, for example a group of students and/or employees from “university1”, would not access the service from the “anybusiness” home page but from the page http://www.carshare.biz/university1/home. Thus, each of the differing groups of individuals would have a separate home page and each individual in a group would be restricted to logging in to the home page of their particular group. Each group also would be operated as a separate entity with regard to the ridesharing and other services provided by the system.

A workspace window 401 makes up browser display 400 in this example. Window area 402 includes a plurality of interactive options that when invoked may bring up additional browser windows relevant to those options. Reading from top to bottom in the list of options, an option for viewing a corporate map is provided. This option may simply be a tool for the commuter to use to browse sections of the company he or she is employed with, for example, to look up the corporate location or department of another commuter. An option exists for enabling the commuter to invoke a links page wherein useful links may be listed.

An option for enabling a commuter to view his or her own profile, or that of another commuter is provided. In the some embodiments the user can only view their own profile. They cannot view any other user's profile.

This option may also provide for editing capability if the invoking commuter owns the profile being viewed. An option for viewing statistics is provided and is adapted upon interaction therewith, to bring up an additional window for ordering specific statistics related to commuting activities. In a variant of this option, a commuter may be empowered to input certain query data and receive a statistical report customized according to the input. For example, how much money have I saved this week considering my make and model of my vehicle and the price of gasoline for the week relative to may commute activity for that week. Another report available may be more generic like the total impact on the pollution index for the total commuting activity for my company for a given historical period. The system would use standard values and known commute variables for the period to calculate the result. There are many possibilities.

Another feature allows a user to put in their commute distance, price they pay for gas and mpg for their vehicle. The system provides a running total of miles, gas, gas money and CO2 saved for the current month, previous month and the total from the time they first used the system.

An option is provided in sidebar 402 and adapted to enable the commuter to retrieve current weather information. This option may be a link to a third party service that may be interacted with in a separate browser window. Two options “publish ride offer” and “search ride offers” are provided according to one embodiment of the present invention whereby interaction with either invokes the appropriate window for publishing or for searching published offers currently in the system.

In this example, window 401 may be a welcome page or commuter home page, which may be personalized by the commuter. Log in or sign in options are available in one embodiment in a manner dependent on the user description before a home page is displayed. For example, in the upper browser bar there are interactive indicia for employee sign in (404), for ETC sign in (405), or for administration sign in (406). Depending on these options, the appropriate data fields appear in window 401. A data entry field 408 is provided for entering an email address or user name. A data entry field 409 is provided for entering password or personal identification number (PIN). A check box is provided for remembering the password or PIN on the user's computing device.

Once the proper authentication is entered for a registered user, a sign in option 407 is provided for signing in. A new or information window 403 is provided for displaying any relevant company information or third-party provided information. Commute news and other information may be displayed on the log in page or after the user has signed in and it at his or her home page. A new user registration option 411 is provided for facilitating registration. Upon invocation of this option a new window may appear containing registration form fields.

FIG. 5 is an exemplary screen 500 invoked through interaction with option 411 of FIG. 4. Screen 500 has a workspace window 501 including a grouping of data entry fields 503 for facilitating new user registration. Grouping 503 includes an entry field for email address and a subsequent entry field for confirming the email address of the user. Typically the email address is one that identifies the user with respect to his company, however that is not specifically required, as any email address may suffice.

In some embodiments if the user does not have an email address that matches one of the email address extensions listed, he or she cannot participate. Otherwise the applicant is not given permission to use the system. By making the system company specific, only allowing employees of that company to use the system this makes it a more appealing system for employees and the employer. This feature enhances the participation rate at the company.

A data entry field is provided for creating a password or PIN and a subsequent field is provided for confirming the entered password or PIN. Form field group 503 also contains a check box for allowing the accessing device to remember the password on that device. Interactive indicia 504 is provided within window 501 and adapted, upon invocation thereof, to submit the entered data to register the new user with the system. In this respect, the new user may be a commuter, an ETC, or an administrator. Once registration is confirmed, a home page is made available for the user and he or she may begin using the system.

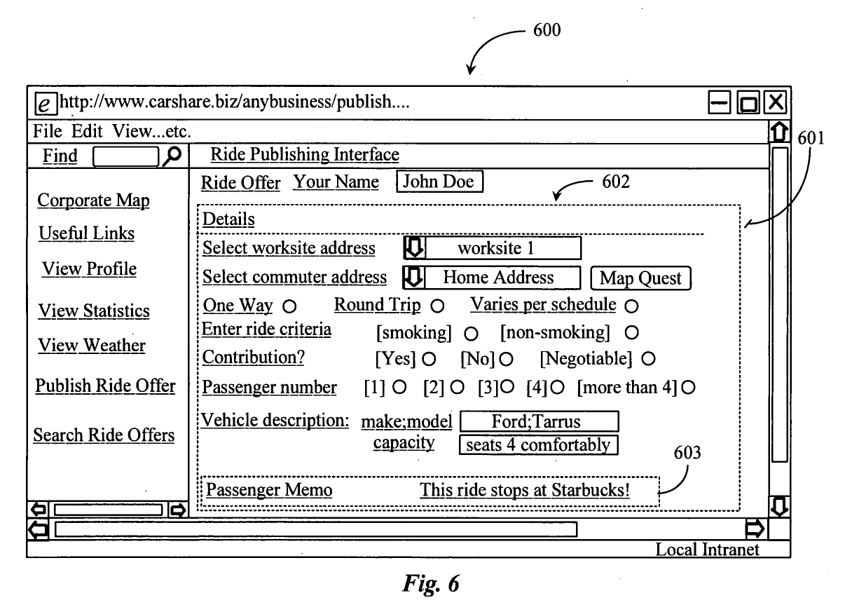

FIG. 6 is an exemplary screen 600 illustrating a publish ride configuration window according to an embodiment of the present invention. Screen 600 may appear if for example, a registered commuter is signed in and invokes the option publish ride offer in the side bar window 402 described in screen 400 of FIG. 4. Because the user is now known to the system he or she need not reenter any name or email address information.

A workspace window 601 contains a publishing form or configuration interface 602 that the user may populate and interact with to publish a ride offer. A drop down menu is provided within interface 602 and is adapted to enable selection of a worksite number that the driver specifies as the destination location for rides. In some cases, of co-located worksites, more than one worksite may be specified as destination points. The worksite may also be the site for picking up riders for a return trip.

A drop down menu is provided for listing the driver's home address if the driver so desires. In one embodiment, a pickup cross street location is used as a demarcation point for the commute to the destination worksite or sites. In this case, the home address may not be relevant and may not be provided as information to potential riders. An interactive link to a mapping service such as Map Quest™ is provided to enable riders looking at the offer to map out the location to meet, for example, for the commute to work. In still anther embodiment, the driver may offer to pick riders up from their home addresses.

In some embodiments of the present invention it is the driver that provides cross street location information. This communicates to potential passengers the general home location of the driver—it is not intended as a pickup point. For most situations drivers pick up and drop off passengers at passengers homes. Therefore passengers are asked for their home location. They may put in their full address if they do want to be picked up from their home. However they do not have to.

The driver's email address will be available to the potential passenger. Therefore the potential passenger can contact the driver directly via email—they do not have to send their request through the system. The drivers may, or may not have, also provided a telephone number for the potential passenger to contact them directly.

A row of options is illustrated below the drop down menus that allow the driver to specify whether the ride offer is one way, round trip, or if it varies according to schedule. If the driver checks the box of any of one way, round rip or varies per schedule, a schedule details form, not shown, may be caused to appear so the driver may configure, for example the days of one way and/or round trip commutes. An option is provided for entering some desired rider criteria or constraints for riders associated with the offered ride. In this case, the user may choose from [smoking] or [non-smoking]. There may be other options as well such as food and drink allowed or no food or drink. There is a text box that allows the driver to define any conditions or requests from potential passengers before the passengers ride request can be considered.

A set of check boxes is provided for enabling the driver to note whether a contribution may be required such as to help with gasoline costs of the driver. The options are [Yes], [No], or [Negotiable]. In some embodiments the driver can specify ‘negotiable’ in the ‘notes to potential passenger’ text box, if they wish.

In some embodiments the driver may also advertise how many passengers he or she has a capacity for. As a courtesy to potential riders, the driver may also enter into provided fields, the make and model of the commute vehicle and the stated capacity, for example, seats 4 comfortably.

A memo box 603 may be provided for the driver to make any suggestions or post any comments with the published offer. In this example, the driver stops at Starbucks™ on the way to work. Window 601 is scrollable and further configuration fields are available by scrolling down.

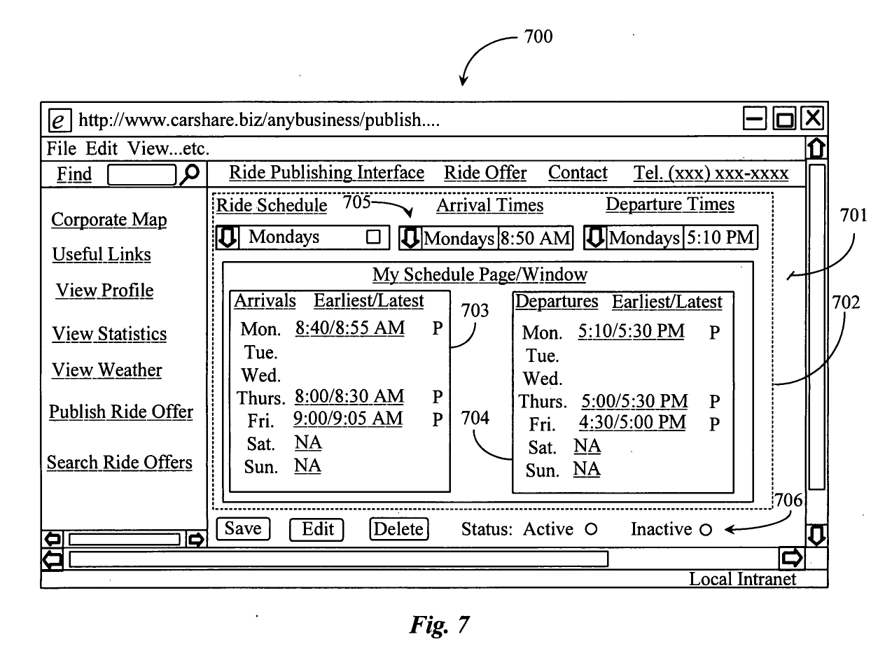

FIG. 7 is an exemplary screen 700 illustrating a next phase of publishing a ride according to an embodiment of the invention. Screen 700 includes a scrollable work window 701 and a continuing publishing form 702 for creating a detailed ride schedule. Ride schedule 702 may be created by using drop down menus 705 that enable the driver to specify the days of the week, arrival times, and departure times for each ride or the offer. It is important to note herein that a ride offer may encompass a complete schedule of repeated rides for ongoing commuting. Once a ride schedule is completed for each day of the week a ride is offered and the offer is published, the editable details may appear on a schedule page or window. In this case, a schedule window 703 illustrates a 7 day schedule of arrivals to a worksite and a schedule window 704 illustrates a 7 day schedule of departures from the worksite. In this case, round trip rides are offered on Monday, Thursday, and Friday of a coming week. The relevant dates of each ride may also be shown on the ride schedule. A P for passenger may accompany each rides indicating that there are passengers currently scheduled for those rides. The indication may be interactive such that upon invocation of “P”, the driver may view the passenger details for each scheduled passenger.

Once a ride offer is completed, it may be saved and published as indicated by indicia 706 provided at the lower left of window 701. An existing schedule may be edited or deleted as well. Status indicia are also provided wherein the schedule may be marked active or inactive. For example, a driver may wish to leave a repeating ride offer in tact but may be on vacation. In this case, the driver may indicate that the ride is inactive so no passengers may request an inactive ride. Likewise, the scheduled rides for the week may be full. In this case the offer may still be published and searchable, but inactive as far as taking on any new riders. If a rider drops off of the schedule, then the offer may indicate the portion of the offer that is available for one passenger.

One advantage of this system is that the host can automatically broker the ride/driver request and acceptance transactions. For example, a driver after configuring an offer may not require the need to review ride requests and manually accept those requests although that is certainly an option. The driver may also submit his or her telephone number if he or she wishes for requesters to have it for negotiating purposes. In some embodiments, the offer is automatically populated with passengers who have indicated acceptance of the offer on a first come first served basis. Thus, each week the driver simply refers to his or her ride schedule to make sure there is at least one passenger. If not, the driver is free to request a ride from some other driver on that day where no passengers are booked. A time period for cutoff of requests may be enforced so that the driver is not inconvenienced by last minute ride requests. This gives the driver time to plan alternate forms of commute instead of SOV.

In some embodiments, where there are more ride requests than is required to fill the ride, the driver can reserve the option of reviewing the rider details for each request and selecting which requests will be accepted. All of his activity may be brokered by the host by facilitating the transactions through the interface. It is noted herein that if a rider or driver does not edit the schedule, then the system may be programmed by default to assume that the defined commute did indeed take place at the specified time. Riders and drivers may make edits to their own schedules such that the system receiving those edits can generate the appropriate alert messages to all affected parties of the commute. In this way commuters are relieved of much responsibility in trying to remember who to notify that they cannot drive a particular day on the schedule or that they cannot ride a particular day on the schedule.

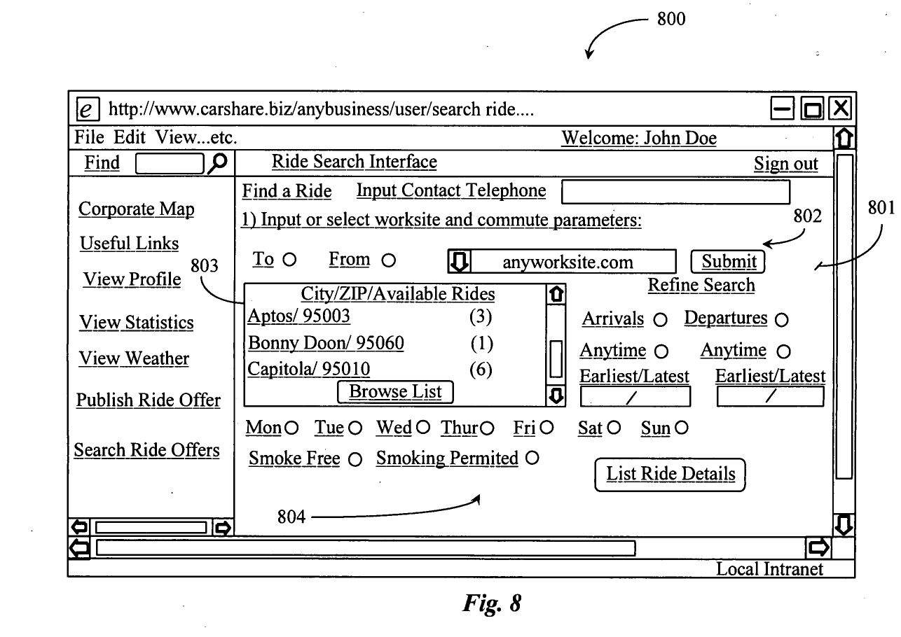

FIG. 8 is an exemplary screen illustrating a ride search interface according to some embodiments of the present invention. Screen 800 includes a workspace window 801 containing various fields for populating data that may be required to search for published ride offers matching the criteria. In this case, the screen welcomes John Doe, the current user. Indicium 802 provides a facility to find rides in the system. For example, check boxes for “To” and “From” are provided along with a drop down menu for selecting a worksite as the commute destination for the request. A data entry field is provided for the ride requestor to input his or her telephone number if not already known to the system.

A plurality of check boxes 804 enable the ride requestor to complete a relatively complex ride search by allowing the requester to submit a request for multiple rides at one time. By checking, for example, Mon, Wed, and Fri, the requester is looking for a single offer that facilitates those days. In one embodiment, if there is no single ride offer that meets the requestor's needs then multiple ride offers are presented, the combination of which may meet those needs. The system knows the requestors ZIP code and email address so that the results are filtered appropriately. Check boxes are also available for matching riders to drivers based on smoking, non-smoking, or other criteria. Likewise, options are available for a ride requester to refine a search by specifying the arrival and departure time windows for each requested ride. The requestor may simply check any time if so desired and browse resulting offers to select which rides are acceptable for requesting the ride.

A result summary window 803 is illustrated in this example and contains a list of available rides that may be searched simply by entering Cities and ZIP codes local to the requestor. These rides may not match the rider's criteria exactly but the rider may search or browse the list to expand details of each offer to see if the offer would fit. A refined search returns a list of ride offers or combination offers that together would most closely match the criteria entered. The relevancy of each offer may be a criteria in listing the results, for example, the most closely matching ride offer first in the list and so on.

A rider may invoke any of the listed results to expand the menu and ultimately obtain the ride offer details for review before submission. For example, in the summary list, rides servicing Aptos/95003 include three active ride offers. After expanding the list of the three offers servicing Aptos, the rider may select any one of those offered rides to view full details by invoking “List Ride Details” located at lower right in window 801.

In some embodiments, the system consults the full details of each available ride offer and may construct or suggest combinations (more than one driver) which would most complete a riders schedule breaking it down to individual one way trips or commute legs. For example, if a rider requests a round trip ride on Monday from Aptos area to a worksite, then the system may produce a ride offer for taking the rider to destination and a different ride offer for taking the rider back to Aptos from the destination, the combination matching the round trip requirements of the rider. The flexibility of a data-integrated system of the present invention enables the rider to search according to a desired commute scenario and the system attempts to fill the schedule first with one ride offer, then by combining ride offers until the schedule is satisfied with available rides.

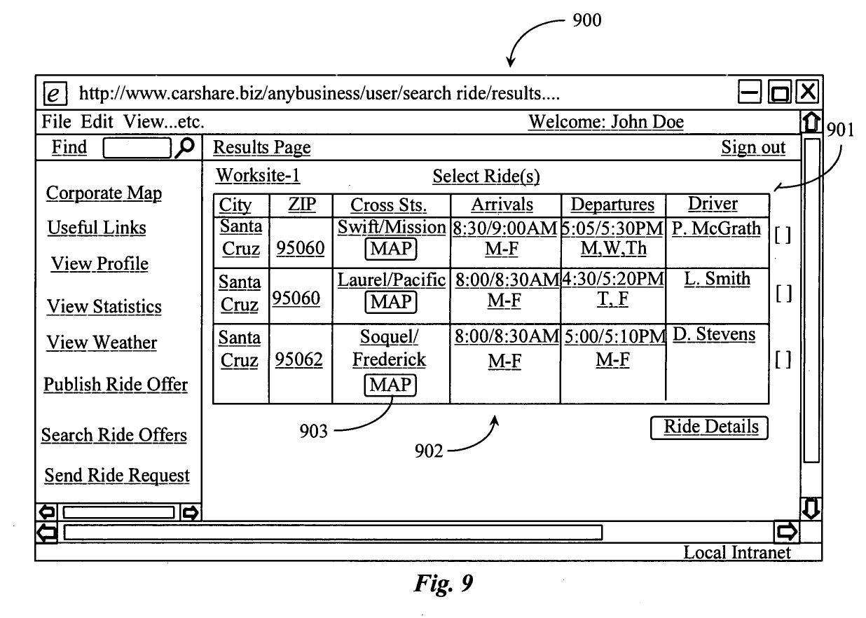

FIG. 9 is an exemplary screen 900 according to some embodiments listing available rides 902 returned as a result of a search for available rides configured and submitted to the system. On this results page 901, the worksite is identified and by default, the company is known. There are 3 rides 902 listed in the results page. The first ride services Santa Cruz 95060 and picks up passengers at the intersection of Swift and Mission streets to take them to worksite 1. A map button 903 may be available to link to a map of the region demarcated by the cross street reference.

The purpose of listing the cross street intersection i.e. Swift and Mission is not to specify a particular pick-up or drop off point for passengers, moreover it is a way to communicate to the potential passenger the neighborhood that the driver is commuting from/to. Passengers will generally look for drivers that are in, or closest to their own neighborhood. In most circumstances after a ride request has been requested and accepted the driver will pick up and drop off passengers at passengers homes. Because of their proximity this will not be a significant hardship for either. However the system allows other arrangements. Drivers and/or passengers can make alternative pick up/drop off requests in ‘notes to potential passengers’ or ‘notes to driver’ text boxes.

Departing rides drop off the passengers at the same intersection in this example. The driver offers rides to the worksite every workday, but does not offer departing rides on Tuesdays or Fridays. The arrival and departure time windows are visible as is the name of the driver, P. McGrath, which if invoked may bring up the driver's published ride information for review.

Assuming that the requestor in this case needs a ride to and from work every day of the week, the first ride offer does not fully satisfy the rider's requirement. However the second ride listed services Santa Cruz and provides the departures requested by the rider that the first ride offer does not, namely departures on Tuesdays and Fridays. In this case, the driver could request a combination or the entire first offer and a partial of the second offer from a driver L. Smith to complete his or her needs. In this case, the rider has to depart from and be dropped back to Laurel and Pacific on Tuesdays and Fridays instead of Swift and Mission. In some embodiments the cross streets are just to indicate drivers neighborhoods—not pickup and drop-off points.

Additionally, a slight time window variation on the arrival and departure times is involved. The second ride may be expanded to view schedule details and only the commute legs may be requested.

In this way, the system attempt to insure maximum rider ship and provides a benefit of fluidity in variance of riders that can lend to a more exciting commute experience where one does not ride with the same exact group all of the time. List 902 contains a third ride offered and servicing Santa Cruz whereby the pickup and drop off intersection is Soquel ad Frederick. This ride offered by D. Stevens provides arrivals and departures from the worksite according to the commuters needs, however it may be listed third in relevance because the intersection may be furthest from the commuter's home and the commuter may have to walk to the intersection. However, if the user could ride a bicycle easily to the intersection of Soquel and Frederick, then he or she might prefer the third offered ride. By invoking the interactive indicia “Ride Details” any of the selected rides in list 902 may be expanded to full ride schedule details.

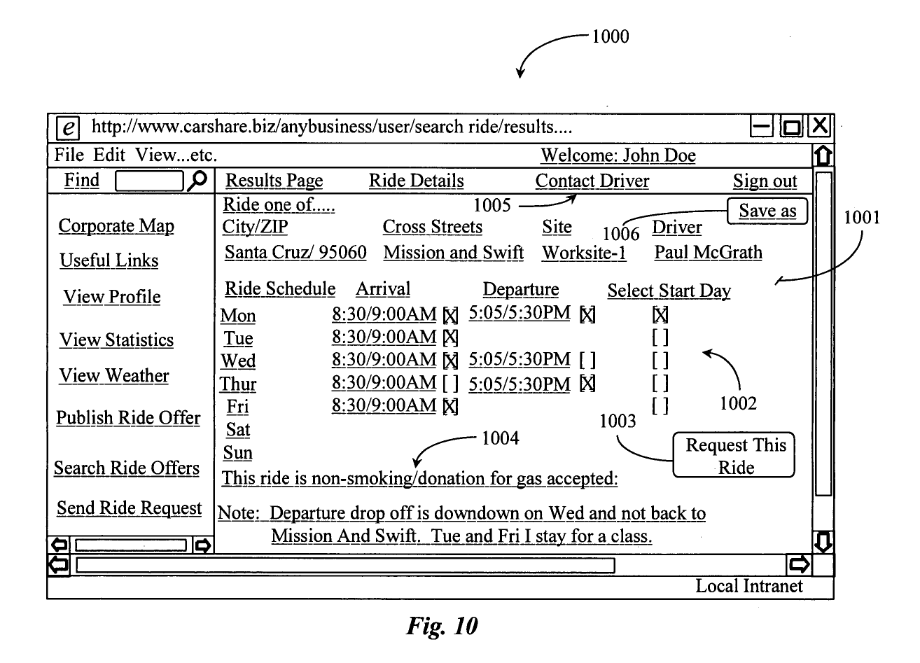

FIG. 10 is an exemplary screen 1000 illustrating ride details expanded from a results list of rides according to an embodiment of the present invention. A workspace window 1001 includes a “full details” ride schedule 1002 for a ride servicing Santa Cruz 95060. Details 1002 are the result of expanding the first ride offer listed in results list 902 described above with respect to FIG. 9. In this expanded format, al of the arrival time windows and departure time windows are illustrated for each commute leg offered. In this detailed schedule, a potential rider may mark any of the listed commute legs he or she wishes to submit as a request. Likewise, a column of check brackets is provided for selecting a start day for commute legs that repeat each week.

Further details that are viewable include a criteria from the driver 1004 relevant to smoking and contributions, and a note to requestors that departure drop off is downtown Santa Cruz on Wednesday and not back to Mission and Swift. Further, the note explains why there are no departures on Tuesday and Friday. An option 1005 is provided on the browser bar above window 1001 for contacting the driver, which in this case is Paul McGrath. An option 1006 also exists for saving the ride schedule information for later configuration if required. Save as indicia 1006 may be used to save the information to a “My Rides” page, which may be referred to as “myDrivers” page in some embodiments.

A ride request option 1003 is provided to enable the user to request the ride as marked up. In this case the potential rider may only select the commute legs that he or she needs to fill out their own commute schedule. In some embodiments, the system works to fill up everyone's commute schedules in order to maximize rider ship. Moreover, allowing a requestor to select specific commute legs may provide a more interesting and diverse commuting experience for both rider and driver. As long as a commute leg has been granted to a requester and that requester has not cancelled the leg, it is assumed that the passenger took the commute and that the driver provided it. By this assumption process, the system can tally all of the commute points and statistics automatically in some embodiments. In some embodiments users need to manually claim points on the “Claim acPoints” page. This makes the system equal for carpoolers, bikers, walkers, transit users, etc. This allows users of different commute modes to be treated equally.

In some embodiments, using an honor system, any driver or passenger that did not actually partake in a commute leg can report that information to the system thereby causing correction of the number of alternative commute (AC) points awarded. In some embodiments points are not automatically tallied.

In some embodiments, the request this ride indicia 1003 sends a request to the host server, which may automatically book the request provided it is offered and open for the requested commute leg or legs offered. In some embodiments, instant confirmation is returned to the requestor (automatic acceptance) and the commute data is added to the riders “My rides schedule page” thus adding the transacted commute legs and associated information to the rider's commute schedule. Likewise, the information is replicated to the driver's schedule such that the next time the driver checks the passenger and details are added and available for review.

In some embodiments, the driver and the requester may conclude a transaction off line, and actually, most transactions may be concluded off-line as this may be how most users wish to use the system, and one or the other may update his or her schedule and replicate the information into the others schedule. The system now has the latest schedule of both rider and driver. The system may update information periodically or may keep it current as transactions occur. An important benefit is that whether one is a driver or rider or both, they may access their schedules quickly and determine what their commute status is with respect to each planned day of the week.

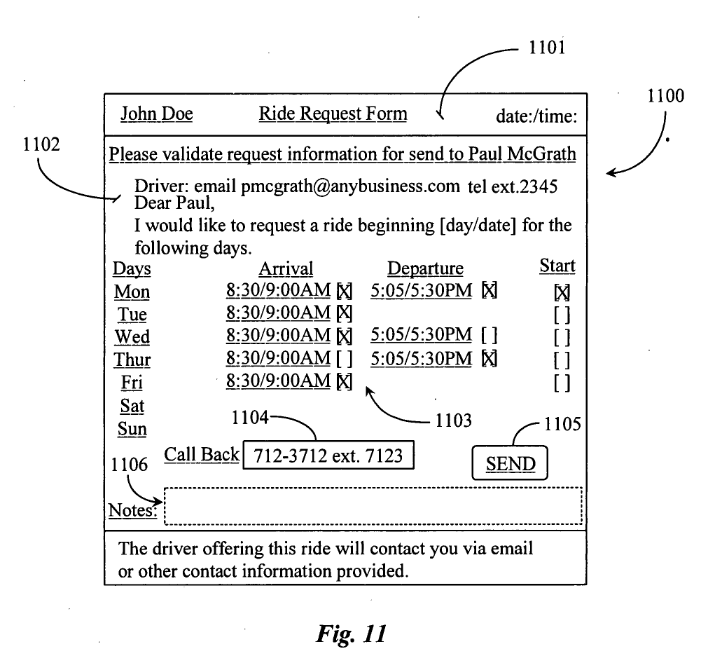

FIG. 11 is an exemplary request form 1100 for confirming the intended request data for the potential rider. This form appears in this example in the form of a message having a header 1101 and a message window 1102. The request may be made to pop up like an instant message alert on the driver's system if he or she is online or the next time he or she logs into the system. Header bar 1101 identifies the requestor [John Doe] and the date and time of the request. A system message asks the requestor to validate the request information before sending to insure that it is correct.

In some embodiments driver contact information is also provided, for example in this case, as email and telephone extension for the driver. The message starts Dear Paul, I would like to request a ride beginning [day/date] and lists a marked ride schedule 1103 with the requested commute legs identified. The requestor desires Monday as the start day for the ride as indicated by an X placed in the far column of brackets. In some embodiments the potential passenger requests a ride on ONE DAY only. Driver and passenger may work out their full commute details when they carpool or talk on the phone. This may be easier and more attractive to users.

A data field 1104 is provided for inserting call back information such as a call back telephone number in case the driver has any questions before accepting the ride request. In some embodiments the ride is automatically accepted if the commute legs requested are still active and available for passengers. A text box 1106 is provided for the requestor to ad any notes or concerns that he or she wishes the driver to know. An interactive send button 1105 is provided to send the message. A system note at the bottom of the message, in this example, informs the requestor “the driver will contact you via email or other contact information provided” (to accept or deny the request). In this case the driver may be reserving the right to personally review and accept or deny requests.

In some embodiments the system note might read “Confirmation of acceptance granted according to ride availability” meaning that acceptance is system controlled based on the availability of the requested commute legs. In some embodiments there is not an automatic acceptance of a ride request. In such embodiments, for all ride requests the driver must manually respond via the system, email or telephone.

If one of the requested legs has been filled in between the time of the request to another rider, then the confirmation would indicate which leg was denied because it was taken or full. In some embodiments, the system-brokered message from the ride requestor to the driver offering the ride is an instant message. In some embodiments it is an automatically generated email from the system the driver on behalf of the requestor. In an embodiment wherein the driver has elected to manually review and accept or deny requests, the replies may be generated through the web interface as instant messages or as system-generated emails. In the case wherein the driver as agreed to allow the system to fill his or her schedule relevant to the offered ride, then the reply to the ride requester may be automatically generated and informs the requestor of acceptance or denial with relevance to each requested commute leg.

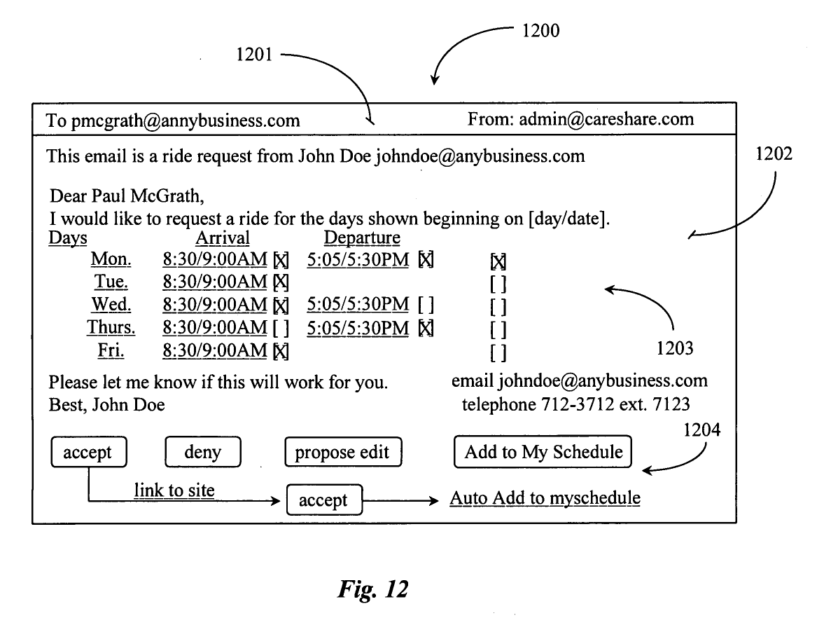

FIG. 12 is a plan view of a generated ride request message 1200 received at the station of the driver according to some embodiments of the present invention. Message 1200 may arrive in the form of an instant message or in the form of an email without departing from the spirit and scope of the present invention. Message 1200 has a title bar 1201 that identifies the recipient address and that identifies the “from” address, in this case admin@carshare.com. In this case, the rider submitted form 1100 and the system generated an automatic email to the recipient identified on the form. In some embodiments, a requestor may cc more than one driver offering rides using just one message.

In this case, the driver has elected to screen requests, instead of allowing the system to automatically fill passenger vacancies.

Also in some embodiments the message 1200 is a message window 1202, within which the message body and some interactive options are presented. Message body 1203 includes an auto-generated introduction Dear Paul McGrath, followed by the statement of the ride request. In one embodiment, the salutation is more generic if more than one potential driver receives the same request.

Message body 1203 includes the schedule associated with the request wherein the actual commute legs requested are marked. In this case, Monday-Wednesday and Friday are requested arrivals and Monday and Thursday are requested departures. It is noted that the only round trip requested is Monday. This embodiment illustrates the flexibility and fluidity of the system of the present invention.

However, in contrast to the above description, in some embodiments a potential passenger can only request a ride on one day. For this one day they can request arrival and/or departures, if they both exist. This one day is the start of the carpool arrangement. At a later time a driver and passenger may efficiently negotiate a longer term carpooling arrangement while they are carpooling, meeting, talking on the phone or carrying out a discussion with regular email.

The requestor has checked that Monday is the day he or she wishes to begin as a passenger of the driver offering the ride. At the end of message body 1203 there is the closing statement. The contact information of the requester including email address and telephone number is provided upon approval from the requester. In some embodiments, a user's profile is not available to anyone else.

In some embodiments, invoking accept or deny generates a submission message back to the automated system whereby an acceptance or denial message is generated and sent back to the requestor has an instant message reply or as an email reply. In some embodiments, it is possible that the driver and requestor may correspond while off line directly using their own email. In this case, each party must manually update their schedules accordingly.

In some embodiments, the driver may propose an edit to the request to determine if the requester would accept the edit. Such an edit would be sent back to the requestor on condition of acceptance by the driver. The requestor would then accept or deny the drivers counter proposal. The system may broker the entire exchange until a transaction has been completed and confirmed. The accept, deny, and other related functions are in the interactive area 1204 of message window 1202 in some embodiments.

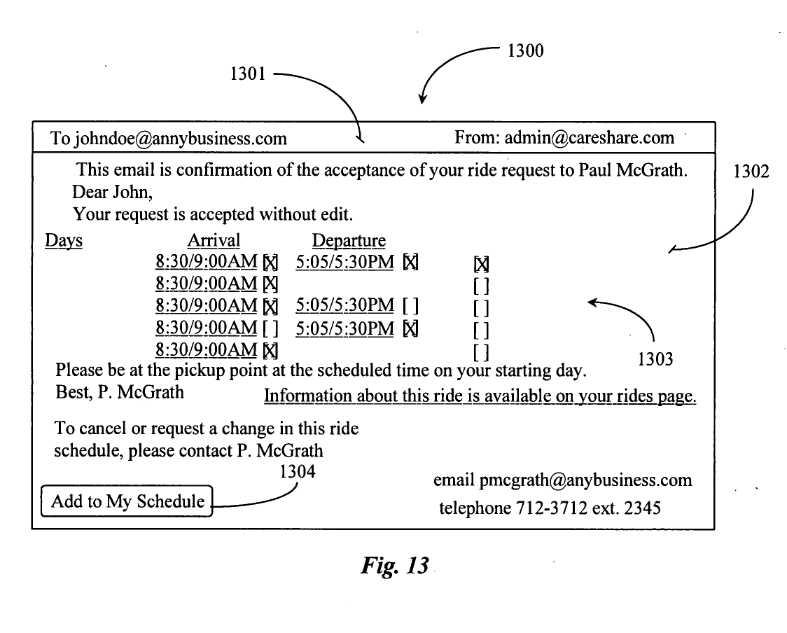

FIG. 13 is a plan view of a message 1300 illustrating that the request of message 1200 has been accepted without edit. Message 1300 may be an instant message or an email message. Message 1300 has a title bar 1301 specifying both the “To” and the “From” addresses. It is noted herein that the “from” address is admin@carshare.com indicating a brokered transaction. In a brokered embodiment, all of the transaction particulars may be automatically added to both schedules involved. The ride information is seen in the ride information area 1303 of the window 1302.

The system has recorded and provides the information about the ride on the recipients ride page. In some embodiments, if more than one acceptance is received as a result of soliciting more than one offered ride, then the ride requestor has the last chance to decide which acceptance he or she will confirm.

A system note informs the requestor to contact Paul McGrath if they need to cancel or request a change in the schedule. The driver's contact information appears in the message window. If the email was not brokered by the system, rather directly between the participants, then invoking an “add to my schedule option” 1304 in window 1302 navigates the requestor to a schedule page where the ride details may be manually added. In the case of brokered transactions, the information may be automatically added without user intervention.

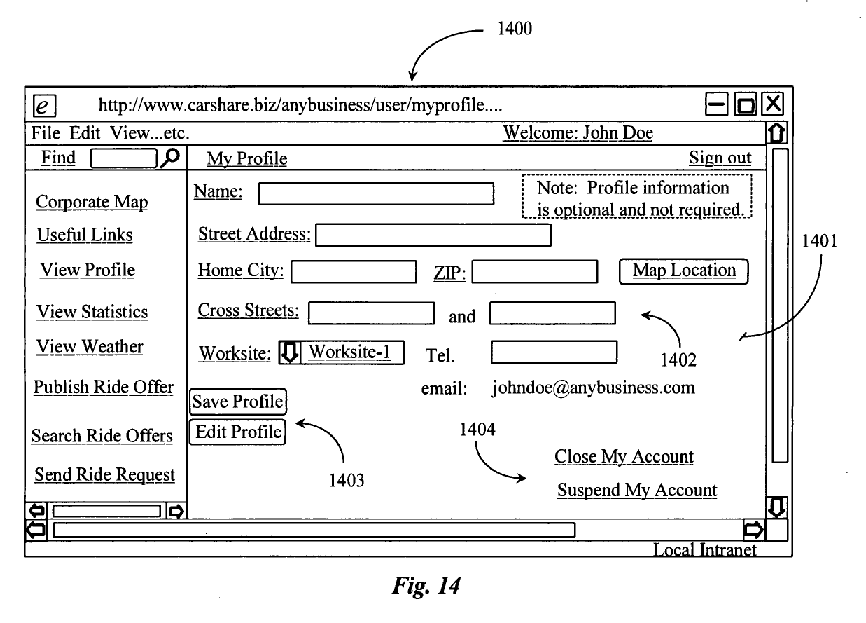

FIG. 14 is an exemplary screen 1400 illustrating an interface for viewing and editing a user profile. Screen 1400 has a workspace window 1401 containing a group of data entry fields or a form 1402 for creating a profile. A name field is provided along with a field for entering a street address, home city, and ZIP code. If a user desires, he or she may also provide a map by invoking an interactive indicia labeled map location.

A system note informs a user that profile information including street address is optional and is not required. In some embodiments, a user may simply state a set of cross streets instead of entering a home address. In this way the actual home address of the user is not available to others. A drop down menu is provided for selecting the worksite of the user, as is a field for entering the telephone number of that worksite. A user may save his or her profile information or edit a current profile by interacting with indicia 1403 adapted for the purpose. Options 1404 enable the user to close his or her account, or to suspend an account temporarily, such as while on vacation or the like.

In some embodiments, presence information may be tagged to a user in the system at any time upon action of the user. For example, if a user must change worksites suddenly, then the user or the ETC may sync the new data with what is in the system. In this case any current schedule already in place that may be rendered not accurate because of the change may be purged from the system and all appropriate parties notified by the system.

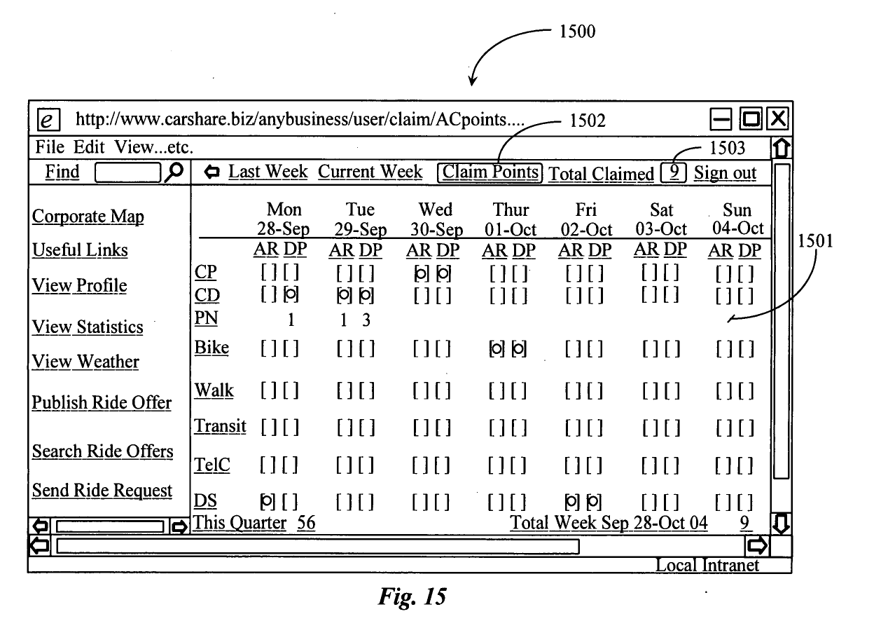

FIG. 15 is an exemplary screen 1500 illustrating a record of alternate commute (AC) points tallied as a user participates with the system of the invention. As previously described above, as an incentive to commute using alternate forms of transportation, the system is customizable at the level of the ETC to provide an incentive scheme or program wherein points earned can be exchanged for some rewards. In some embodiments, a user may accumulate points earned to use a currency for prizes, as exchange medium for cash prizes, or as entry requirements for company sponsored lotteries. In some embodiments the points are entered into a prize lottery. In some embodiments, the points are used in other ways.

Screen 1500 has a workspace window 1501 containing a plurality of fields enabling the system and the user to insert points for alternate commuting tasks completed. The screen illustrates a current week just completed. The week tallied runs from Monday September 28 to Sun October 4. An option for previewing a previous week is available on the title bar of screen 1500. Points can be entered for the previous and current week. A radio button exists for each commute leg taken in terms of alternate commutes to a worksite and alternate commutes from a worksite.

Several horizontal rows intersecting with columns representing each day of the current week enable the system or the user to activate radio buttons according to the type of activity that occurred with respect to each commute leg. For example, on Monday the user was a carpool driver (CD) departing from the worksite and has a radio button activated. The first horizontal row is for carpool passenger (CP). The user was not a commute passenger on Monday or on Tuesday. However, he or she was a CP on Wednesday for arrival and departure and therefore has both radio buttons activated. On Tuesday, the user was a CD both for arrival and departure from the worksite and has both radio buttons active.

The third horizontal row tallies the number of passengers on commute legs where the user was a CD. On Monday, the user drove 1 passenger. On Tuesday, the user drove 1 passenger to the worksite and drove 3 passengers from the worksite for a total of 4 passengers on that day. If one point is awarded for being a passenger and one point is awarded for each passenger the user drives when he or she is a CD, then for ride sharing in the current week the user has 7 points.

The next 4 horizontal rows describe alternate forms of commuting other that ride sharing, for example, biking, walking, transit, and telecommuting from home. Vanpooling is an additional option. Other alternative modes can easily be included.

On Thursday, the user rode his or her bicycle to and from a worksite. If each of those counts as one point then the user's total AC points are 9 points earned for the week as indicated. The bottom horizontal row indicates when the user drove to and from work solo (DS). The system may automatically fill this in after all of the AC buttons are activated. No points are, in this case, awarded for solo driving, however for statistical purposes, the information is still important as will be explained later in this specification.

In some embodiments, the system automatically tallies points according to the user's schedule as long as no cancellations are indicated that may indicate a scheduled ride was not actually taken. The user may correct the system in the case where some change was not uploaded into the system such as a last minute problem or crisis that derailed the scheduled activity. The user may activate buttons for any alternate forms of commute taken using an honor system. The system may be aware of some of these without user intervention such as a telecommuting schedule, which may be part of company mandated policy. For example, “Mondays and Fridays are telecommuting days for employees at worksite 1”. In some embodiments all users are treated equally. All have to claim their own points. There are no automatic points being tallied.

A user may view the total accumulated AC points for any given period such as “This Quarter” as indicated at lower right of workspace window 1501. An option 1502 located in the title bar of screen 1500 allows a user to claim points for use in obtaining prizes, entering a lottery, or for discounts on third party services. Vouchers may be emailed or otherwise sent to user's claiming AC pints whereupon a document verifying the points may be printed out at the user's station. Such a document may be used at a restaurant, for example, to obtain a free meal. In some embodiments, the document may be stored on a user's mobile device and then displayed for a service person providing third-party services and cooperating with the incentive scheme. The document may be such that once it is displayed it cannot be displayed again. The number of points claimed may be viewed in a distinct area 1503.

As far as defining an exact incentive scheme, there is some flexibility for each company registered with the service of the present invention. For example one company may offer cash rewards of, for example, $500.00 to the most prolific alternate commuter followed by $250.00 for second, $100.00 for third and so on. The period defined can be arbitrary. A company may hold a lottery that may be entered if a certain number of points are accumulated.

In some embodiments the incentive scheme works as follows: For every alternative commute journey you make you earn one point. If you are a carpool driver you earn a point for every passenger, for every journey you make. You can keep note, track and claim your points in acPoints for the current week and for the previous week. Each point you have earned gives you a chance at winning prizes in the next drawing. i.e. there is no ‘threshold’ of points needed to be entered into the lottery. Just one point claimed could win the top prize. Every point claimed provides a chance of winning. It is the ‘raffle ticket’ model. Every point claimed is equivalent to one ‘raffle ticket’.

Likewise, a company may make any local third-party arrangements for discounts on products and services. In this case, a special software voucher or document that is read only and one time executable could be provided for those who claim AC points to use when patronizing those third-party establishments.

In some embodiments, using statistics, companies may compete against each other for host-sponsored awards, recognitions, press or the like. For example, if a regional or even national company had the most AC points tallied for all of its employees for any given period they could enjoy National recognition in the press as a “Good Neighbor” and part of the solution to congestion and pollution. In the same light, its name gets out to the public helping with marketing.

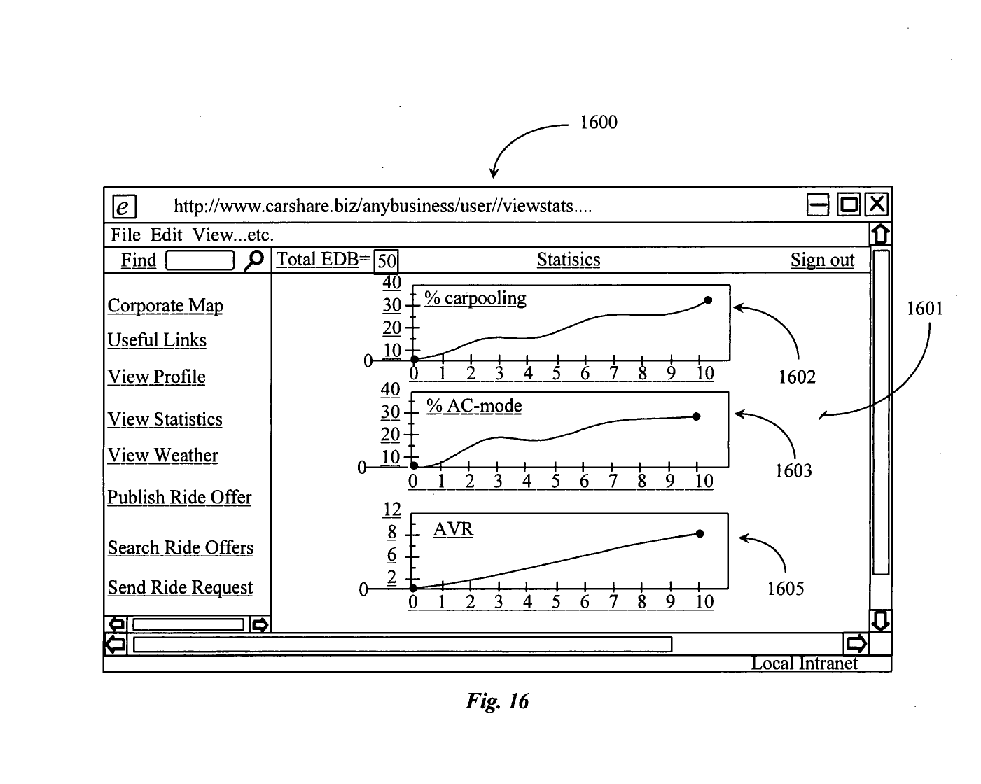

FIG. 16 is an exemplary screen 1600 illustrating system generated statistical reports according to an embodiment of the present invention. Screen 1600 has a workspace window 1601 containing a plurality of charts, carpooling chart 1602, alternative commute chart 1603, and average ridership chart 1605. By clicking on “view statistics” in the side bar area of screen 1600, the user can order customized reports according to a wide variety of criteria. For example, chart 1602 shows the % of company employees that have carpooled over the weeks since the service was available. An ETC may use this information to help plan for additional incentives. Likewise, chart 1603 shows the percentages of employees that used a form of alternate commute other than carpooling over the same 10-week period. Chart 1605 shows the average rider ship (passengers) in car pools over the same 10-week period. These more generic statistics might be used primarily by management or an ETC to evaluate success of the system.

In some embodiments, employees using the system are able to get much more personal statistics related to their own activities. For example, one such report might generate values relevant to the amount of monies saved on gasoline for each week since the user started taking advantage of the system. The user would simply provide the make, model, and year of his or her automobile otherwise used to commute as a solo driver.

In some embodiments the user provides the following information to support this statistical generation: Commute miles, miles per gallon, and price they pay for gas. The schedule activity of the user for a week, along with mapping information of the routes taken and the price of gas at those times can be used to reliably estimate the cost savings each week for the commuter.

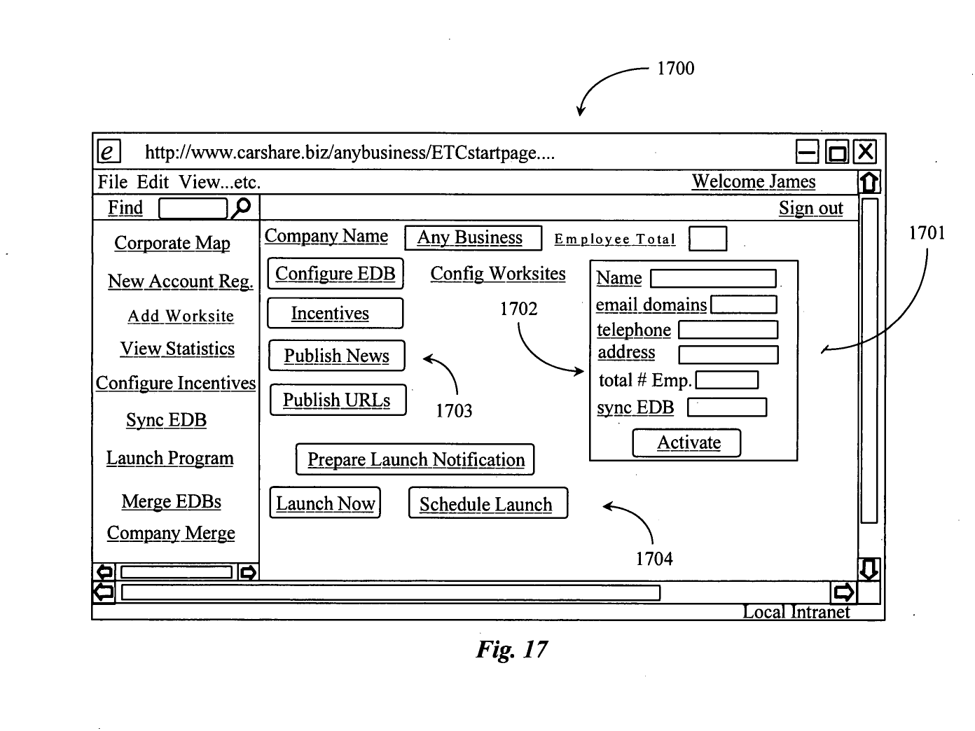

FIG. 17 is an exemplary screen 1700 of WC 112 illustrating an ETC interface for configuring a company account according to some embodiments of the present invention. Screen 1700 may be provided through the system to any new company coordinator that wishes to register a company or add a worksite to the service. Screen 1700 has a workspace window 1701 containing a group of interactive indicia and forms for entering required information to register a company for service.

In this case, the ETC is James and he has already signed in to begin registering his company. A company name data entry field is provided to enter the company name that worksites will be organized under. An entry field is similarly provided for entering the total number of employees for that company. An electronic form 1702 is illustrated for the purpose of configuring worksites. Form 1702 has an entry field for worksite name, the email domain (*@anybusiness.com), and an entry field for main telephone of the worksite. The telephone field implies that one main telephone is available and the workers all have different extensions. This does not have to be the case in order to practice the present invention. For example, many different telephone numbers may be entered and extensions can be added later if they apply.

An entry field is provided for entering the total number of workers reporting to that worksite. An entry field is provided for adding the network address of the employee database or portion thereof affected by that worksite. By syncing the EDB, the ETC enables the system to access the database and to obtain only the employee information that is relevant to the service. For example, the employee's names, telephone extensions, email names, and so on for system use. An activate button is provided for activating the worksite. It is noted herein that there may be more than one ETC for a company wherein each ETC is responsible for one worksite. Likewise a company having multiple worksites may designate a single ETC to manage all of them. Still further a designated number of ETCs may share a larger number of worksites. In many cases there might only be one worksite managed by a single ETC. In yet another embodiment, there might be one ETC designated to manage a group of co-located companies as a coalition or group of companies registered as a single account. An example would be several companies located in a same building or business park.

A group of options 1703 provide backend functions. For example, an ETC may invoke “configure EDB” in order to set up system access to a legacy database system for the purpose of obtaining the relevant information required to run the service. An ETC may invoke “incentives” in order to bring up a new window to create an incentive program that will be used to start the service. Once the required information and database access has been established, the company will receive a web site that will be served to each of the employees who register to use the site. The website may be customized accordingly to provide a custom version for each worker, the versions supported by a generic template or master.

Options are provided that enable the ETC to create and publish news and to publish universal resource locators (URLs) of interest to employees. These items are public and would be visible on the company homepage before a user signs in to the service. At that point the custom version of the home page is displayed. In some embodiments, none of the company specific information, including custom URLs, would be available for public view. All company specific information would be available only to registered users that have signed in.

A group of interactive options 1704 is provided for launching the service after registration. One option enables the ETC to prepare a launch notification, which may be an email message, sent by the system to the total number of employees of the company. This launch notification may also be granulated according to worksite in some cases. An option is illustrated for launch now, and an option is illustrated for scheduled launch. The launch now option immediately causes a system email to be sent to all of the employees detailing the service and incentive program and asking those employees to register. The schedule launch option provides the same notification, but delays the send operation until a time that the ETC feels is optimum to maximize initial viewing of the message.

It is noted herein that the sidebar area of screen 1700 has several new options illustrated therein. One is for configuring new and additional incentives. This option is always open and an ETC may use this option at any time after registering. Synchronize EDB option is illustrated in the sidebar area of screen 1700 and can be invoked any time the ETC has updated the EDB, for example, adding a new hire, deleting a terminated employee, changing worksite assignments, and so on.

In some embodiments, several local companies such as those businesses co-located in a business park may cooperate to merge EDBs at the network level so as to participate in a service encompassing all of those employees as one entity. A merge EDBs function is provided for enabling the system access to all of those databases and a merge company function is provided for any ETC having an account to sponsor additional companies by adding their employees to the worksite or worksites. More detail on this embodiment is provided below.

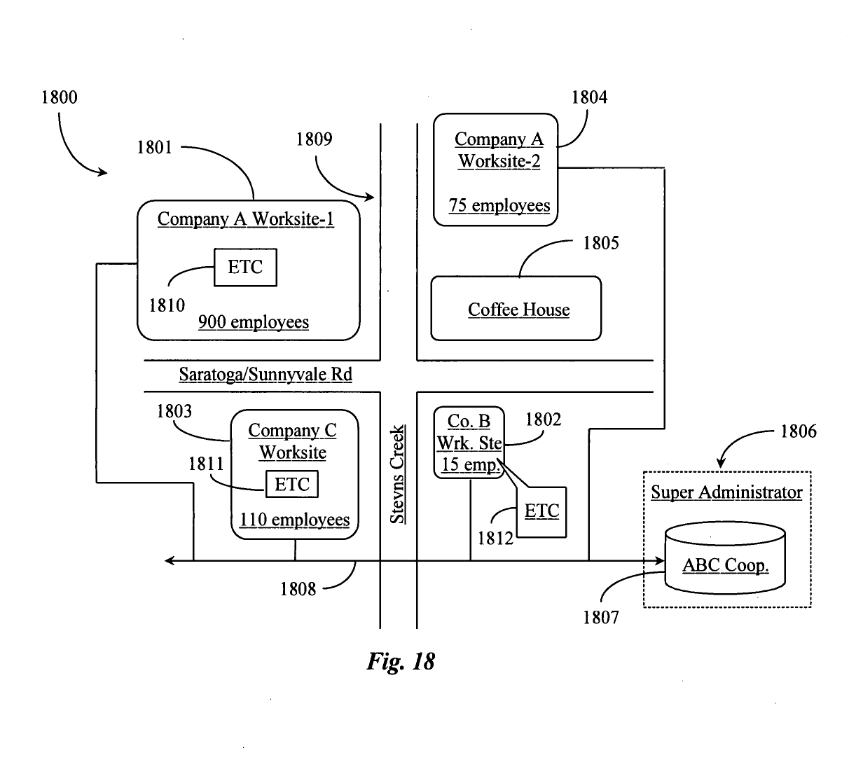

FIG. 18 is a block diagram illustrating cooperation of multiple business services as a single entity according to one embodiment of the present invention. A sitemap 1800 is illustrated in this example and is intended to show a local area used by multiple businesses in a way that might foster cooperation between those businesses to better serve their employees by maximizing carpooling or ride sharing opportunities for all of those employees. A company A, worksite 1 (1801), is illustrated as a business having 900 employees located on the northwest corner of an intersection (cross street) 1809 labeled Saratoga/Sunnyvale Rd. and Stevens Creek. Company A (1801) has an additional worksite-2 (1804) employing 75 employees located almost directly across the street (northeast corner) and at a walk able distance from worksite-1. A company B worksite (1802) is illustrated on the southeast corner of intersection 1809. Company B (1802) only has 15 employees. A company C worksite (1803) is illustrated on the southwest corner of intersection 1809 and has 110 employees.

As separate businesses, all three companies may have their own ETCs and may be registered with the service of the present invention as individual companies. In this case, each company would be considered a separate company at network level and those respective employees are pooled separately as far as offering and searching for rides. Therefore, company B (1802) is at some disadvantage in that there are only 15 possibilities that a driver will be available at any given time to give rides to some of the other 14 employees who might wish to be passengers. Company C has a larger pool to work with. Company A has the largest pool to work with.

Companies A, B, and C are co-located and their respective worksites are close enough to each other for all employees of those companies to walk to any one of them from, say a nearby coffee house illustrated herein as coffee house 1805 sharing the northeast corner of intersection 1809 with worksite-2 (1804) of company A. Both of the smaller companies have an incentive to expand their resources to include the pool of employees of company A In order to maximize the possibility of always finding a suitable match for ride sharing.

Therefore, the 3 companies may elect to merge virtually into one cooperative entity at the network level, interacting along a network connection 1808, which may be a LAN or the internet or other means. In this example, each company has its own ETC, ETC 1810 (company 1801 worksite 1), ETC 1811 (company C), and ETC 1812 (company B). Logically speaking, ETC 1810 would be a good candidate for managing companies B and C worksites because it already manages 2 worksites for company A totaling 975 employees. Therefore, companies B and C may request that their worksites be included in the management of company A worksites 1 and 2 to maximize their opportunities. Because all of the worksites are so close to one another, ETC 1810 may designate the coffee house 1805 as the designated arrival and departure point for all area employees. In exchange for this, the coffee house, because of increased business may offer discounts to all of the area employees earning AC points. The ETC functions of companies B and C may not be required and the system will have access to all of the EDBs involved.

The host in this sitemap is represented herein as a dotted rectangular box 1806 defining a super administrator analogous to AD station 107 described with reference to FIG. 1 above. A network level database 1807 is partitioned to include all three companies and their employ as an ABC cooperative, for example. In one embodiment, ETC 1810 manages all information and creates all incentives for everyone. In such a case, each employee would qualify for any and all prizes offered and benefits created by ETC 1810.

In some embodiments, each respective company maintains it's own local ETC for providing company-specific incentives and only allows all of the employees access to each other (at the network level) in terms of offering rides and searching for available rides by merging company EDBs for common pooling of the relevant information. After the change, each user will still have their own custom version of a web page template shared by all three companies. Each ETC may continue to sync and update its own database, however, the updates may go to ETC 1810 who then may sync to the service. In another embodiment, each ETC may still connect directly with the service, syncing their own databases wherein the only commonality is the network level pool of employees used during ride matching services and communication brokering.

The concept here is that small groups of companies may easily form local coalitions and in turn, coalitions thus formed may further merge to form larger regional coalitions. In this way, carpooling opportunities may be expanded over several geographic grids such as spanning a larger area of several adjacent intersections. Of course, more than one ETC may be required to manage a large number of commuters operating in this way.

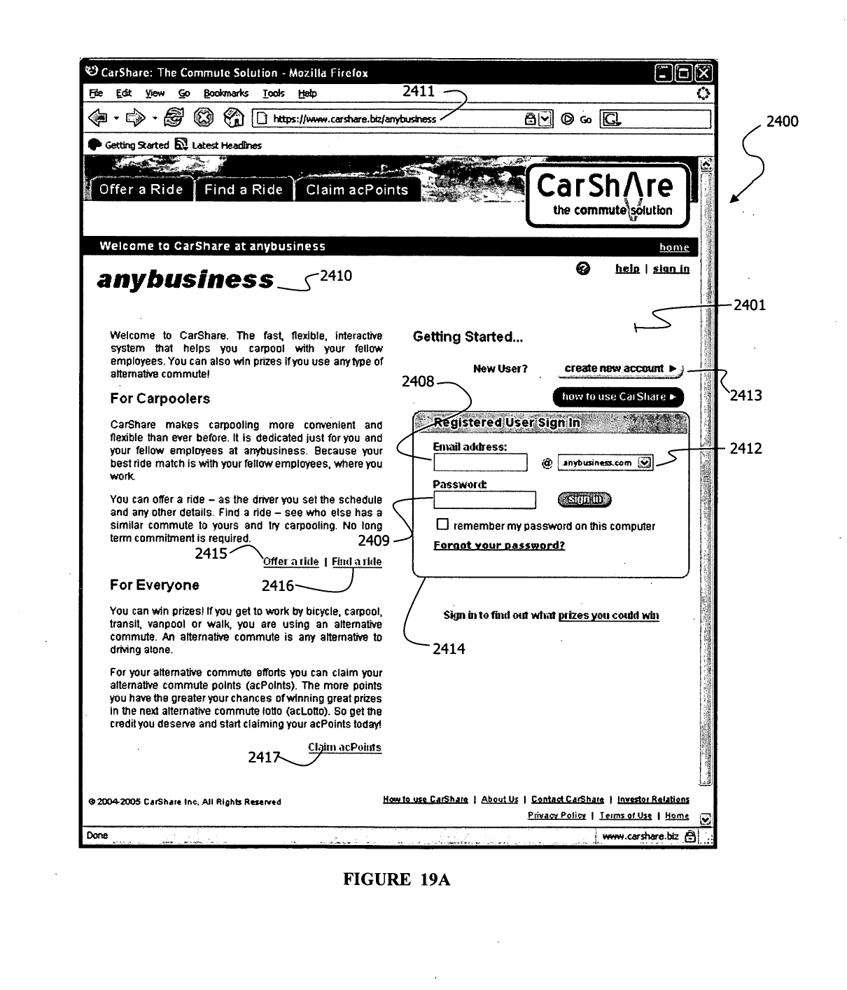

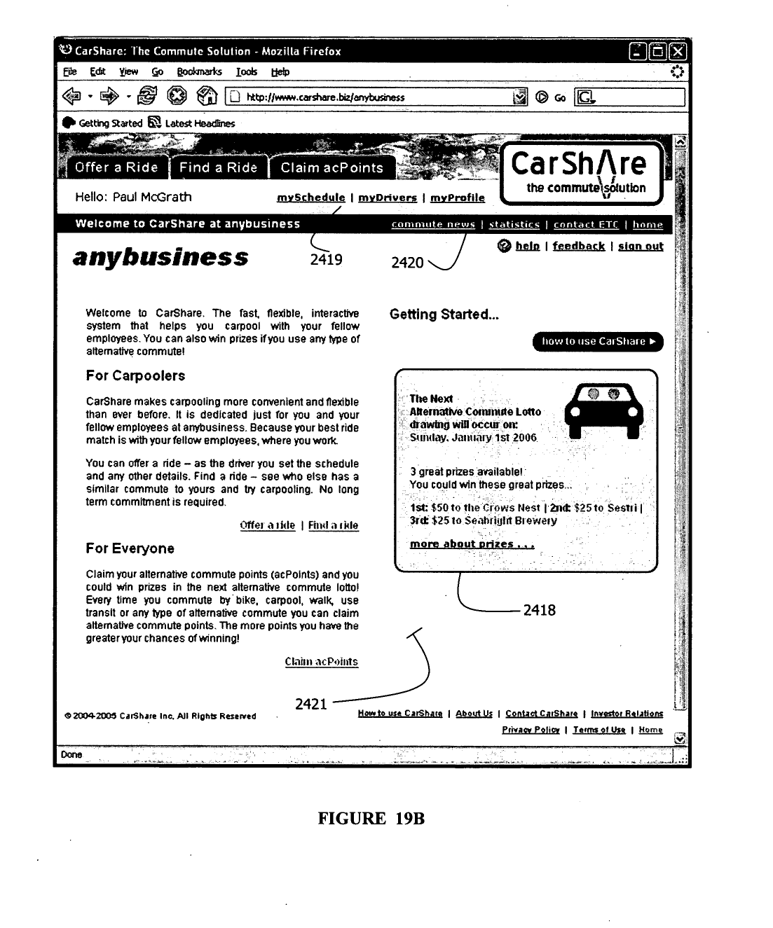

FIGS. 19-36 illustrate screenshots of webpages implementing some embodiments of the present invention. FIG. 19A is a screen shot 2400 of WI 111 of FIG. 1 illustrating commuter log in home page. This commuter log in screen and home page 2400 is specific to a group of users. For example, the URL http://www.carshare.biz/anybusiness 2411 is a home page dedicated to the group of user-commuters associated with the group named “anybusiness”. The group name 2410 is seen on the web page. User-commuters from a different group of users, for example a group of students and/or employees from “university1”, would not access the service from the “anybusiness” home page but from the page http://www.carshare.biz/university1. Thus, each of the differing groups of individuals would have a separate home page and each individual in a group would be restricted to logging in to the home page of their particular group. Each group also would be operated as a separate entity with regard to the ridesharing and other services provided by the system.

The embodiments as illustrated in FIGS. 19-36 involve a web-based application that is fully situated within the hosting enterprise's server or servers. In these embodiments, a group of users, such as a company, does not need to add or alter their computer system in any way to utilize the application, as long as the users have access to the internet (or other global-area computer network). The ETC for such a group is granted a different level of access such that the ETC may make modifications to the web-based application as it applies to that group only. Also, the ETC has access to all information relating to that specific group. For example, the ETC may set which email suffixes can be used for a user to register with the system, and subsequently log in, for that group. The ETC may also be able to list lotto prizes for the group and place announcements in the system as it is accessed by that group.

Although all of the web-based application's software is contained within the hosting enterprise's server or servers, each group is granted access to a segregated and separate website and set of web pages with which to interact.

A workspace window 2401 is seen within home page screen 2400 in this example, as seen in FIG. 19A. A new user from the group may register to create a new account by toggling the button associated with that task 2413. A previously registered user may sign in in the sign in area 2414. A data entry field 2408 is provided for entering an email address or user name. The suffix of the email address is entered using a drop down menu 2412 which will include all of the suffixes of the users from the group, which may be just one suffix. The email suffix must be selected from the list of available suffixes. A data entry field 2409 is provided for entering a password. A check box is provided for remembering the password or PIN on the user's computing device.

The list of email suffixes may be modified by the ETC for that group. The restriction on the email suffixes provides a measure of security so that it is likely that only members of that group will be able to login to the webpages for that group. This security may also function as an inducement to increased participation in the program, as some potential users may reluctant to interact with people outside their group for reasons of personal security or for other reasons. In the case of a company, the limitation of users to employees of that company, for example, may make a potential user feel secure that if a contact developed through use of the system behaved inappropriately that the recourse within the company.

The work space window will change after a successful signing in of an authorized user to a signed-in user window 2421, as seen in FIG. 19B. A box 2418 with general announcements and the like, including announcements about prize lottos, is present. The functionalities associated with the Offer a ride link 2415, the Find a ride link 2416, and the Claim acPoints link 2417 are only available to the user after the user has successfully signed in. If these links are attempted without proper sign in, they will not take the user to the page associated with the functionality per se but instead to a page describing that functionality and which requests that the user create an account. Access links 2419 to the mySchedule, myDrivers, and myProfile windows are now present after a successful sign in. Access links 2420 to the commute news, statistics, and contacts ETC windows are also present after a successful sign in.

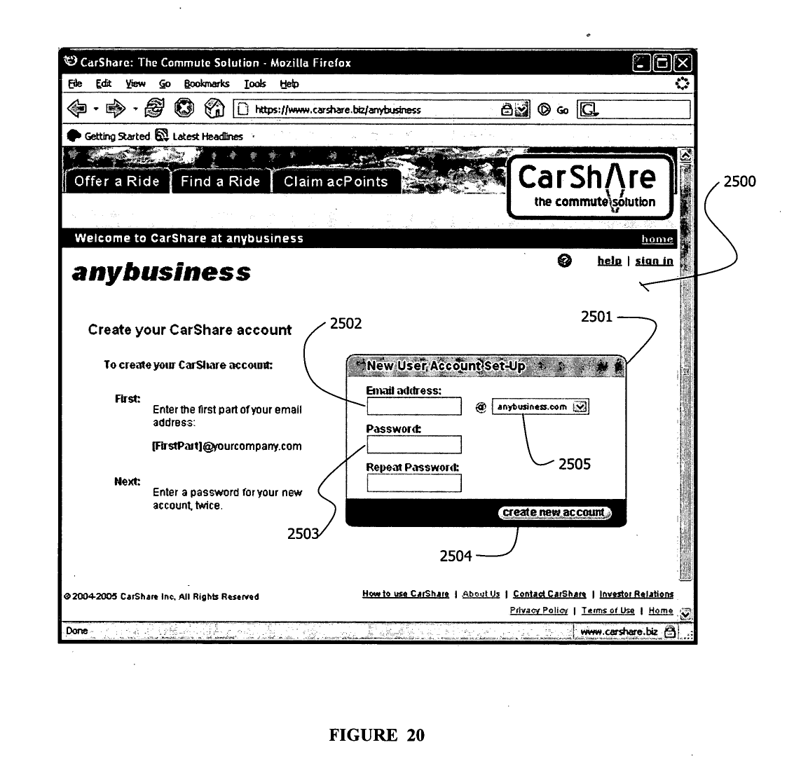

When a user toggles the create new account button 2413, the user is directed to the account creation window 2500, as seen in FIG. 20. The user may enter his/her email prefix in the email address box 2502 contained within the New User Account Set-Up area 2501. The user then selects an email suffix 2505 from those available in the drop down menu. A password is then selected and entered into the password entry box 2503. After the password is re-entered, the create new account button 2504 is selected. This will spur the sending of a message to the user's email address requesting action in order to validate the creation of the account. The email will include a link that brings the user back to the website. The user from this point on will access the service via the home page screen 2400 and will not normally utilize the account creation page 2500 again.

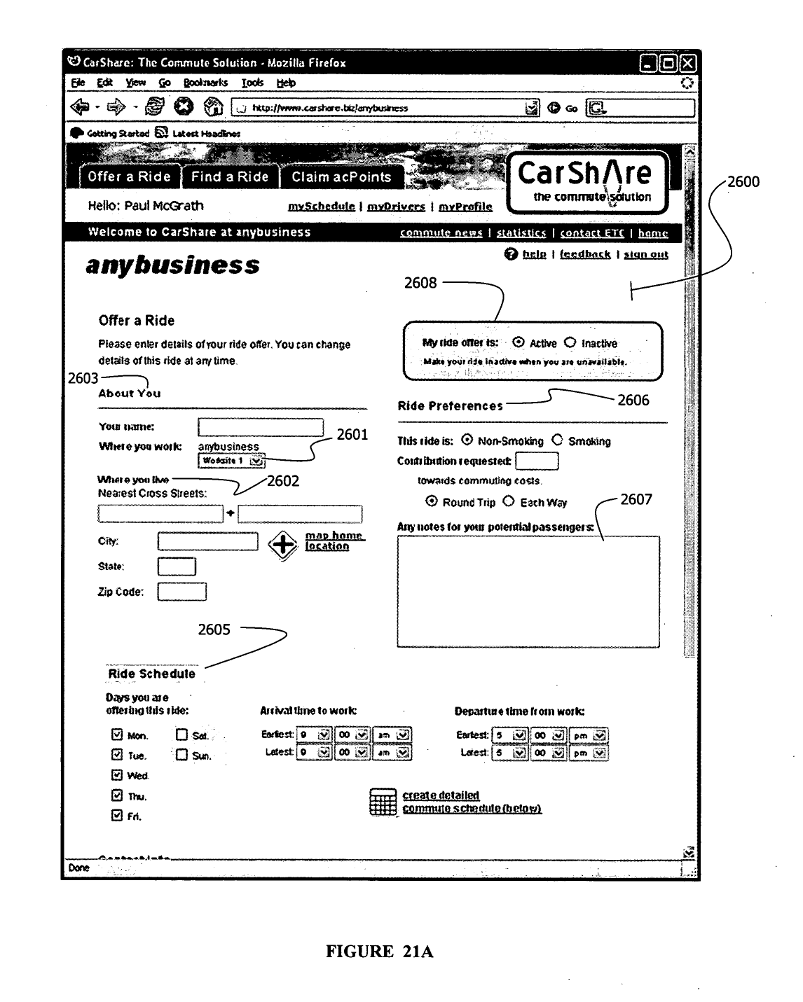

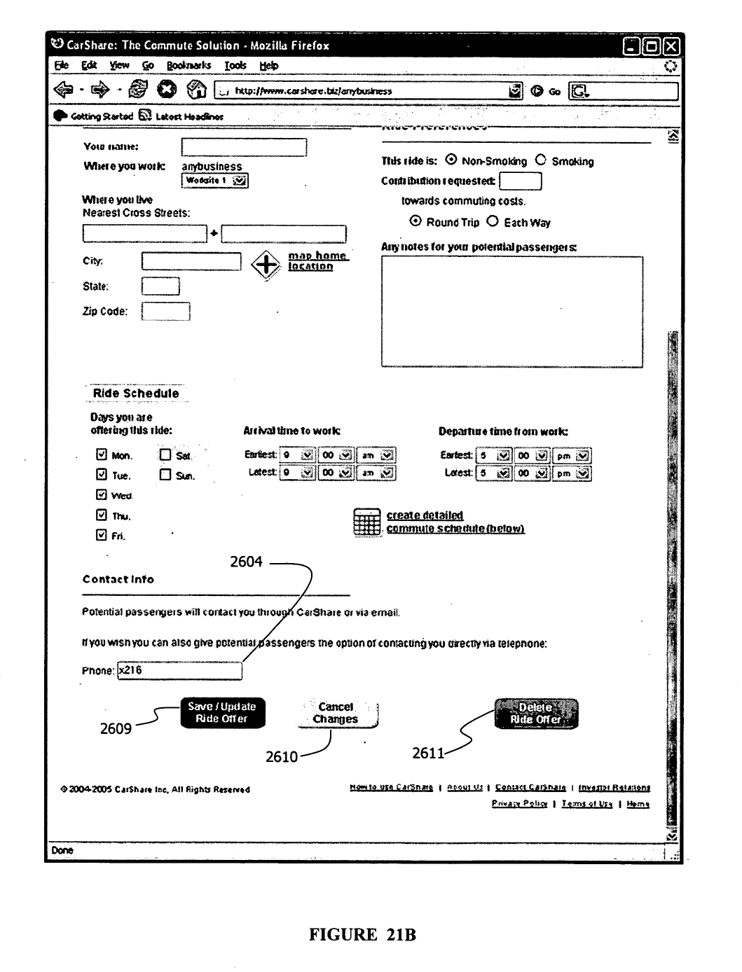

FIGS. 21A-B illustrate the top and bottom half of the Offer a Ride page 2600 that may be reached by clicking the Offer a ride link 2415. The Offer a Ride page 2600 contains a publishing form/configuration interface that the user may populate and interact with to offer a ride. A drop down menu is provided within interface 2601 and is adapted to enable selection of a worksite location that the driver specifies as the destination location for rides. In some cases, of co-located worksites, more than one worksite may be available in the drop down menu as destination points. The worksite may also be the site for picking up riders for a return trip.

Information about the driver is provided in an “AboutYou” area 2603. A “Where you live” area 2602 is provided for the entry of a demarcation point for the commute to the destination worksite or sites. In this case, the home address may not be relevant and may not be provided as information to potential riders. The drivers may, or may not have, also provided a telephone number 2604 for the potential passenger to contact them directly.

An array of options is available in the Ride Schedule area 2605 that allow the driver to specify whether the ride parameters so the driver may configure, for example the days of one way and/or round trip commutes. An area 2606 is provided for entering some desired rider criteria or constraints for riders associated with the offered ride. There is a text box 2607 that allows the driver to define any conditions or requests from potential passengers, or for the driver to make any suggestions or post any comments with the published offer. A set of check boxes is provided for enabling the driver to note whether a contribution may be required such as to help with gasoline costs of the driver.

An activity box 2608 allows the user to inactivate a ride offer. This allows a previously entered, perhaps complex, ride offer to remain set up but not be available for use, for example if the user were taking a week of vacation. At the bottom of the page there are buttons for saving or updating the ride offer 2609, canceling any changes made 2610, or deleting the ride offer 2611. The selection of the Save/Update Ride Offer link 2609 will make the offered ride(s) available to be seen when other users in the group are seeking a ride.

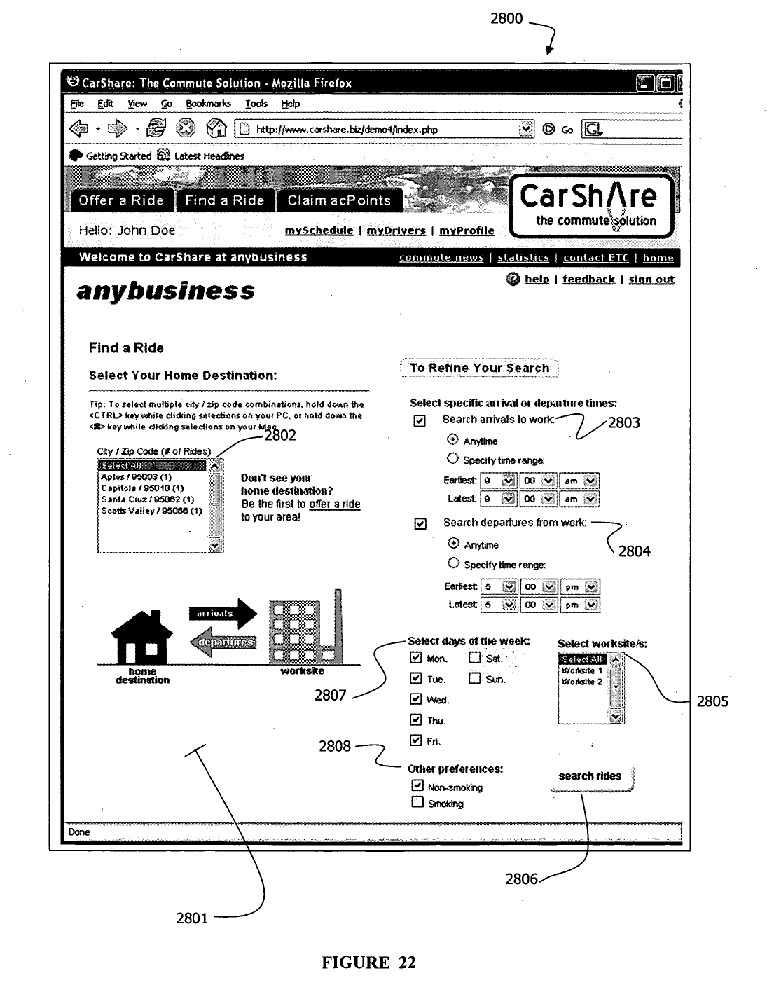

FIG. 22 is a screen 2800 illustrating the Find a Ride function according to some embodiments of the present invention. Screen 2800 includes a workspace window 2801 containing various fields for populating data that may be required to search for ride offers matching the criteria. Menu 2802 provides a list of cities and zip codes available to select as one's home destination, and also allows a search of all rides available. The number of rides available in that zip code are seen in parentheses. If there is a large number of rides available in that zip code area, the user may want to refine their search. A plurality of search criteria 2803 are available to enable the ride requestor to search for times for arrival to work. A plurality of search criteria 2804 are available to enable the ride requestor to search for times for departure from work. The days of the week for which the user is searching for a ride are available to be selected 2807. The worksite is available to be selected 2805. Other preferences are also available for selection 2808. Once the user is satisfied with the selections, the search rides function 2806 is selected.

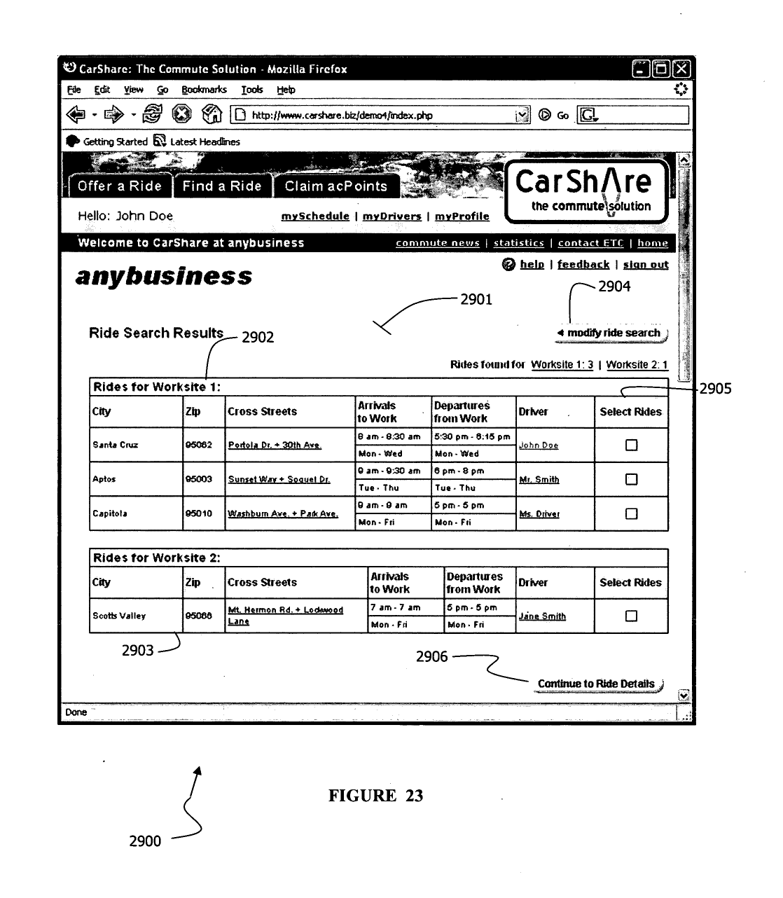

FIG. 23 is an exemplary screen 2900 according to some embodiments listing available rides returned as a result of a search for available rides configured and submitted to the system. On this results page 2901, there are three rides 2902 listed for worksite 1, and one ride 2903 listed for worksite 2. If the user is not satisfied with the results, the user may use the modify the search function 2904 to return to the previous screen. If the user does see a ride or rides that the user likes, the user may select the rides of interest by filling the select rides box 2905 associated with that offer. The user may then get more detail on the selected rides by clicking on the Continue to Ride Details button 2906.

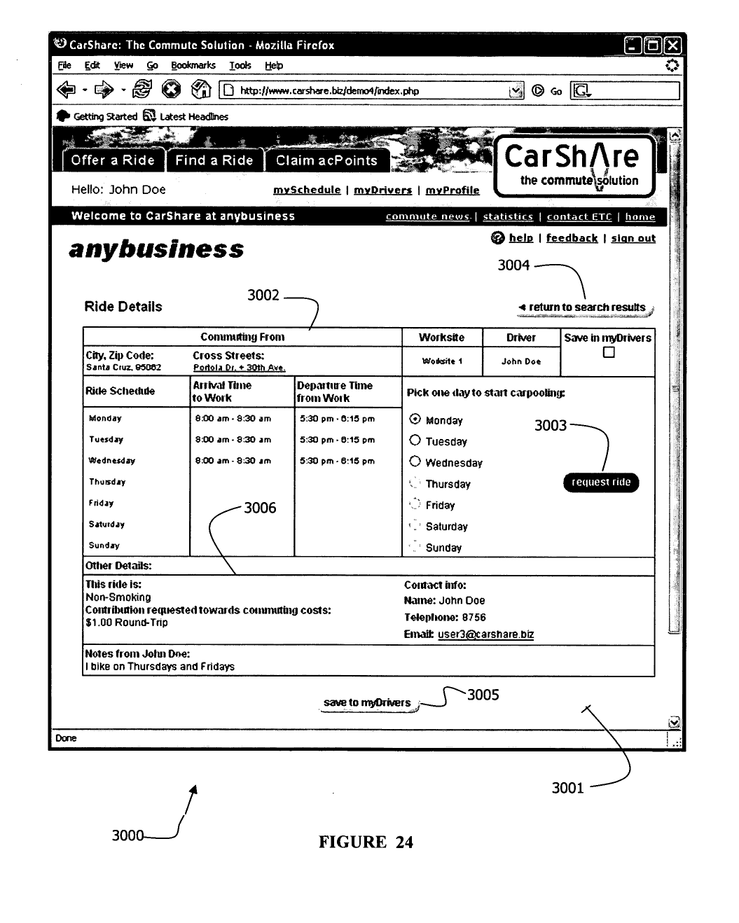

FIG. 24 is an exemplary screen 3000 illustrating ride details 3002 expanded from a ride selected from a results list of rides according to some embodiments of the present invention. A workspace window 3001 includes a “ride details” ride schedule 3002 for a ride servicing Santa Cruz 95060. In this expanded format, all of the arrival time windows and departure time windows are illustrated for each commute leg offered. In this detailed schedule, a potential rider may select a day for which he or she wishes to submit as a request. Only a single day is selected in order to begin the dialogue between the user searching for a ride and the user offering the ride. Further ride agreements made via phone or email once such a dialogue has begun.

Once a ride desired has been selected, the user may select the request ride link 3003 to generate a ride request. If the user was not satisfied with the ride details, the user may select the return to search results link 3004 to return to the prior screen. If the user desires to save the ride information, the user may select the save to myDrivers link 3005.

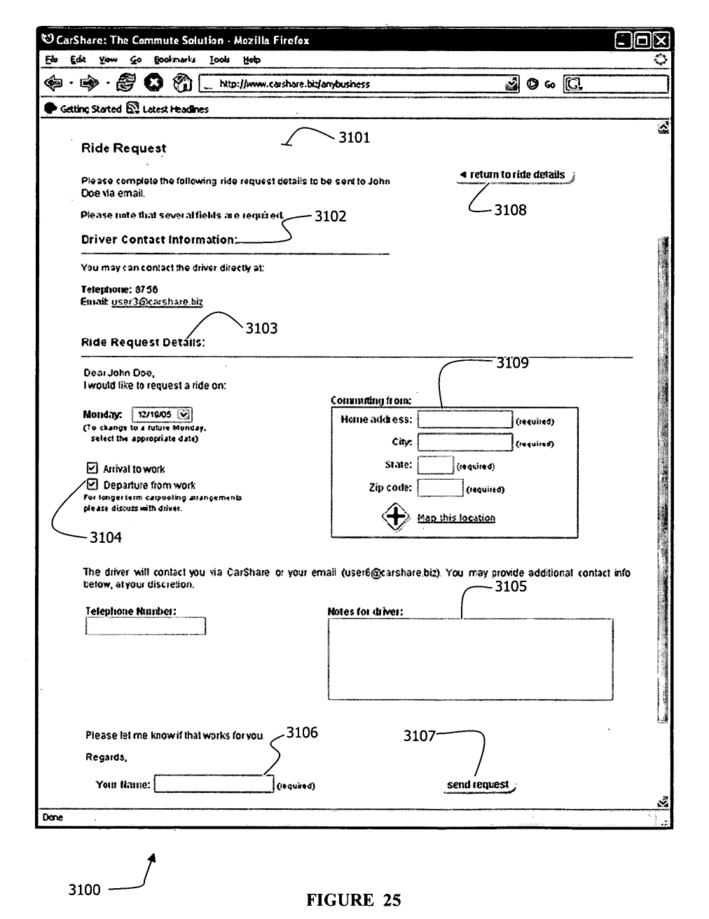

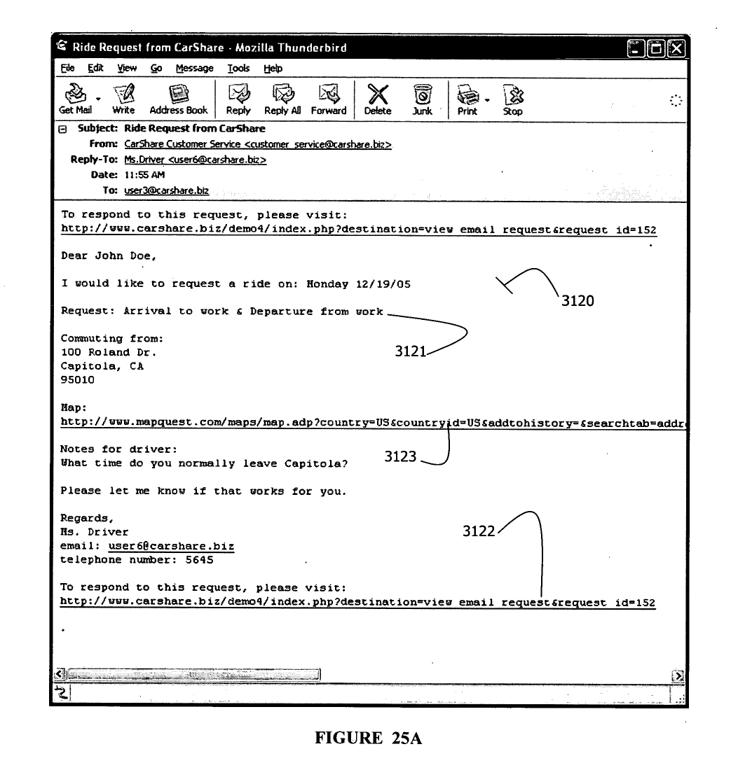

FIG. 25 is an exemplary screen 3100 illustrating a ride request window 3101 according to some embodiments of the present invention. The ride request window 3101 includes driver contact information 3102 as well as ride request details 3103. The ride request details 3103 will state the day of the week selected in the previous screen, although there is functionality to select that day of the week in a later week than the current week. The user may also select whether the request is for arrival to work of departure from work or both 3104. The commuting from box 3109 is where the user puts in information regarding the user's location. The user may also include notes for driver 3105, and enters his/her name 3106. If the user wishes to return to the previous ride details screen, the user may use the return to ride details link 3108. If the user wishes to send the request, the send request link 3107 is used. This will automatically generate an email to the other user who had offered the ride which this user is responding.

FIG. 25A is a screen shot 3120 illustrating the email generated by using the send request link 3107. An email is automatically generated and sent to the ride offeror. The email requests the ride 3121 and states the date of the ride being requested. A map link 3123 is embedded within the email, which can be clicked on and will take the email reader to a web based map of the location of the requester. The email directs the reader to visit a response link 3122, which is an embedded live link which will take reader to a ride request received page 3200 on the web-based application. The notes to driver that the requestor may have included in the request via the web-based application will be supplied in the email.

The use of email requests is especially useful for situation where a group user may only periodically check a web-based application such as this after offering a ride, but is continually on alert for new emails, such as a typical modern professional work situation. Although ride requests may have also been initiated over the phone by the requester, the email notification adds a modern dimension to this system. In addition, the link in the email which take the user to the appropriate page of the web-based application brings an ease of use which may facilitate ease of use and, in turn, overall use of the system.

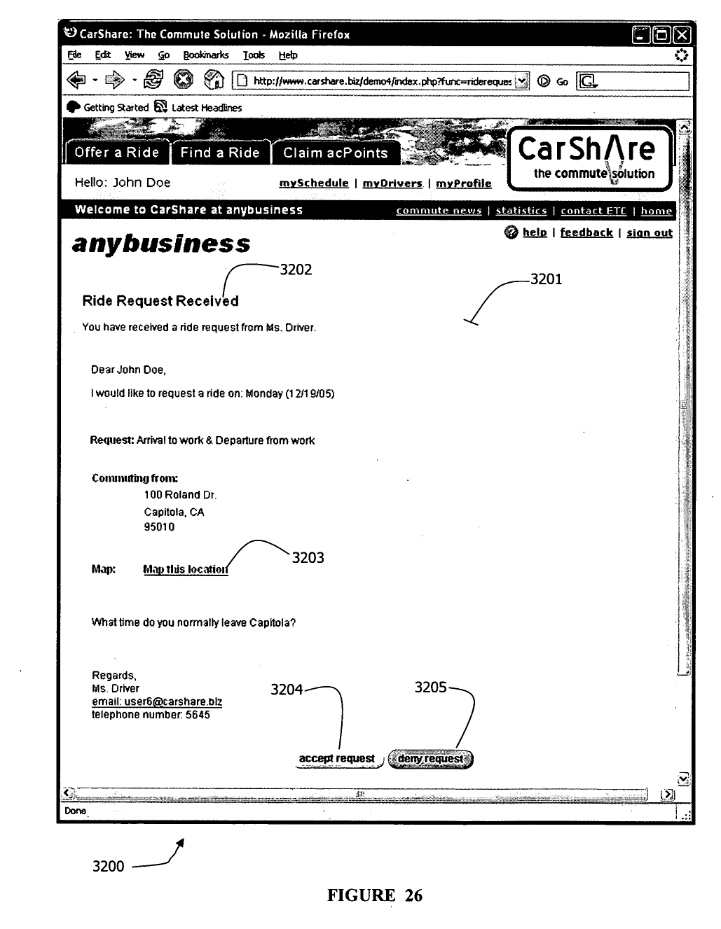

FIG. 26 is an exemplary screen 3200 illustrating a ride request received window 3201 according to some embodiments of the present invention. The window relays the message that a ride request has been received 3202. The requestor's information and message, if any, are within the window 3201. A map link 3203 may be used to show the location of the requestor. The user may accept the request by using the accept request link 3204. The user may decline the request my using the deny request link 3205.

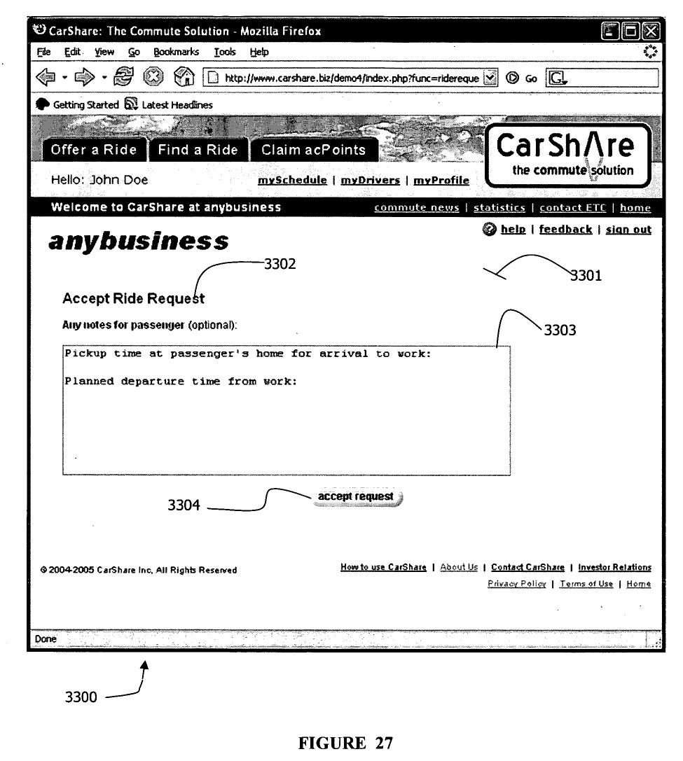

If the accept request link 3204 is used, the user is taken to the accept ride request screen. FIG. 27 is an exemplary screen 3300 illustrating an accept ride request window 3301 according to some embodiments of the present invention. The user may enter the pickup time and the departure from work time in a notes box 3303. To accept the request, the user toggles the accept request button 3304.

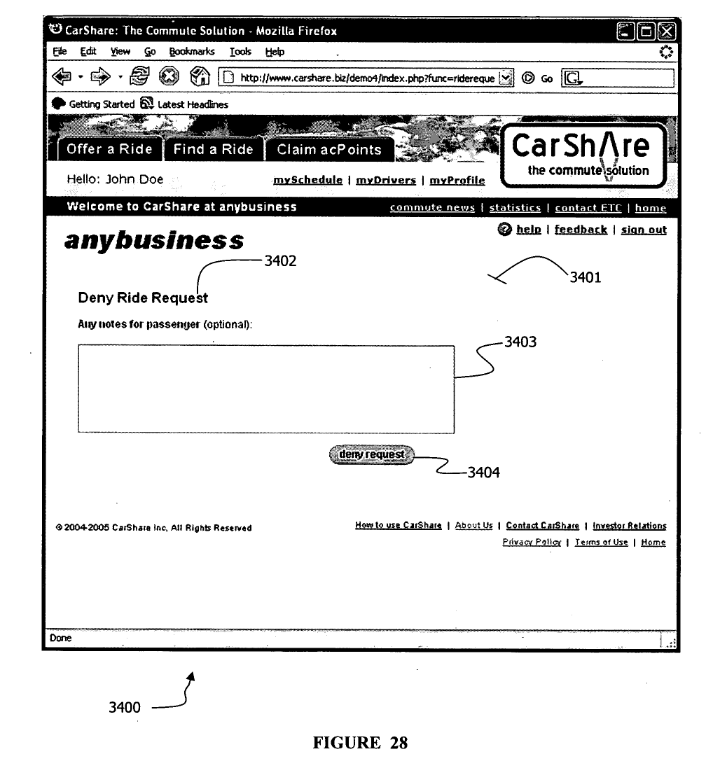

If the deny request link 3205 is used, the user is taken to the deny ride request screen. FIG. 28 is an exemplary screen 3400 illustrating a deny ride request window 3401 according to some embodiments of the present invention. The user may enter notes in a notes box 3403. To deny the request, the user toggles the deny request button 3404.

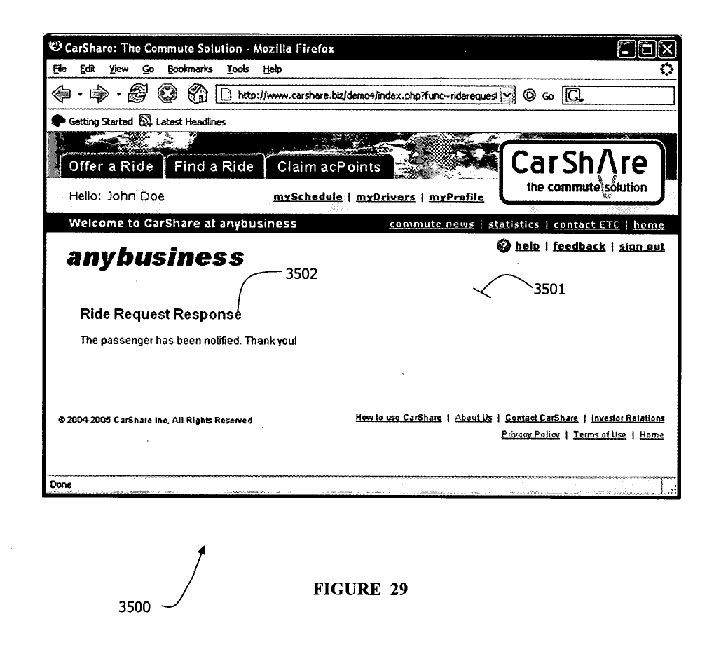

After the user has either accepted or denied the request, the user is taken to a response screen. FIG. 29 is an exemplary screen 3500 illustrating a ride request response window 3501 according to some embodiments of the present invention. The user is told that the ride request has been responded to 3502. The requestor will now be notified of the response via an automatically generated email.

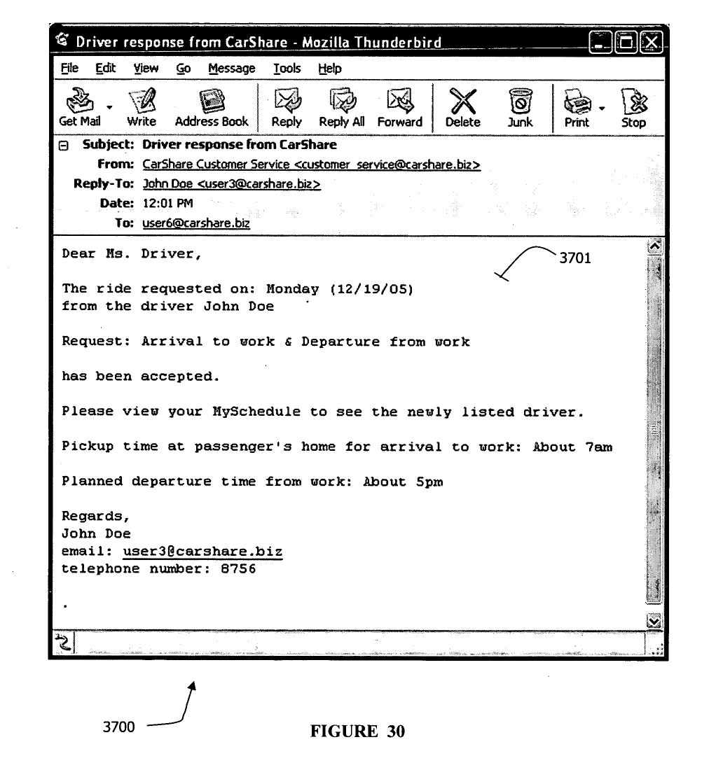

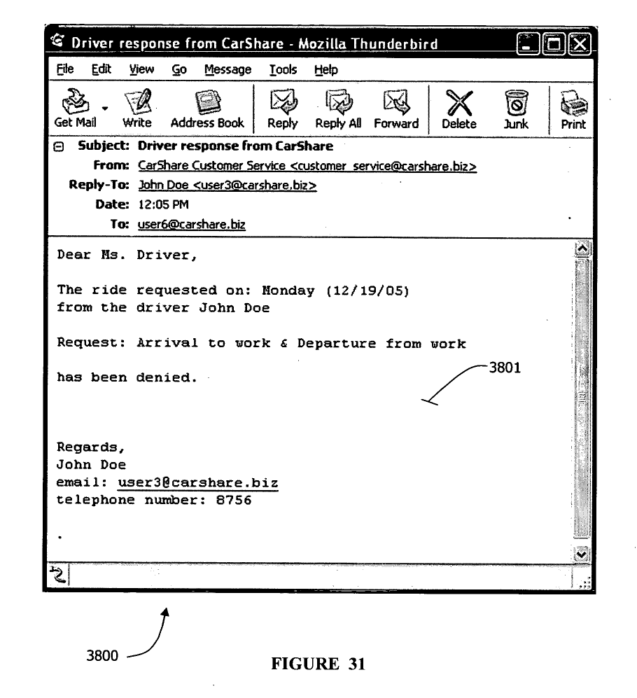

FIG. 30 is an exemplary screen 3700 illustrating a ride request acceptance email 3701 according to some embodiments of the present invention. The user is told that the ride request has been accepted. The notes entered by the offeror regarding times are also included. FIG. 31 is an exemplary screen 3800 illustrating a ride request denial email 3801 according to some embodiments of the present invention. The user is told that the ride request has been denied.

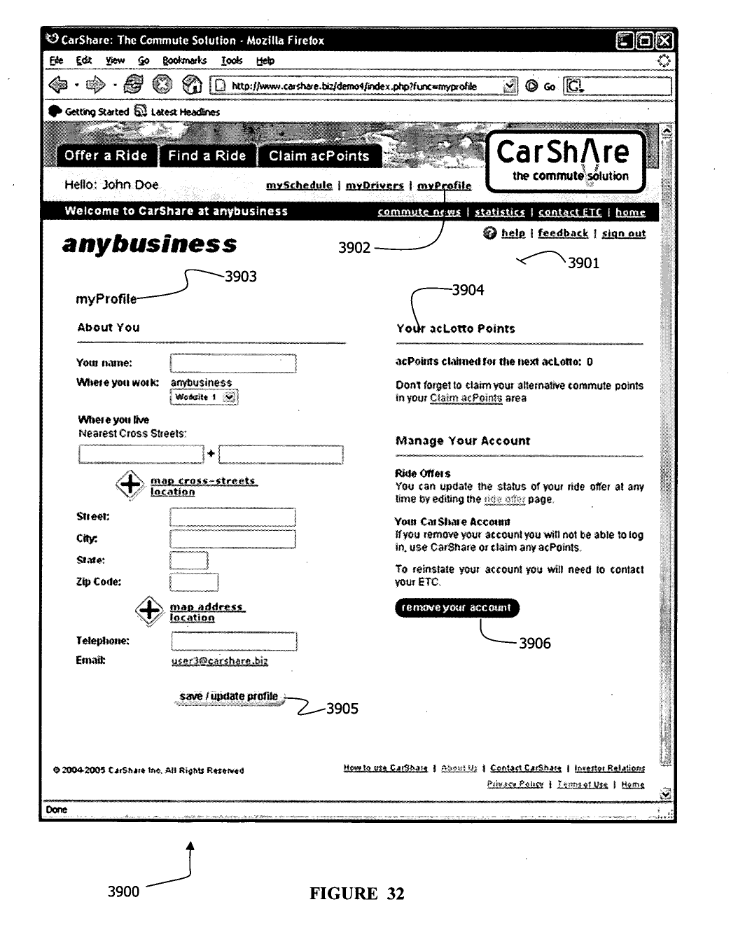

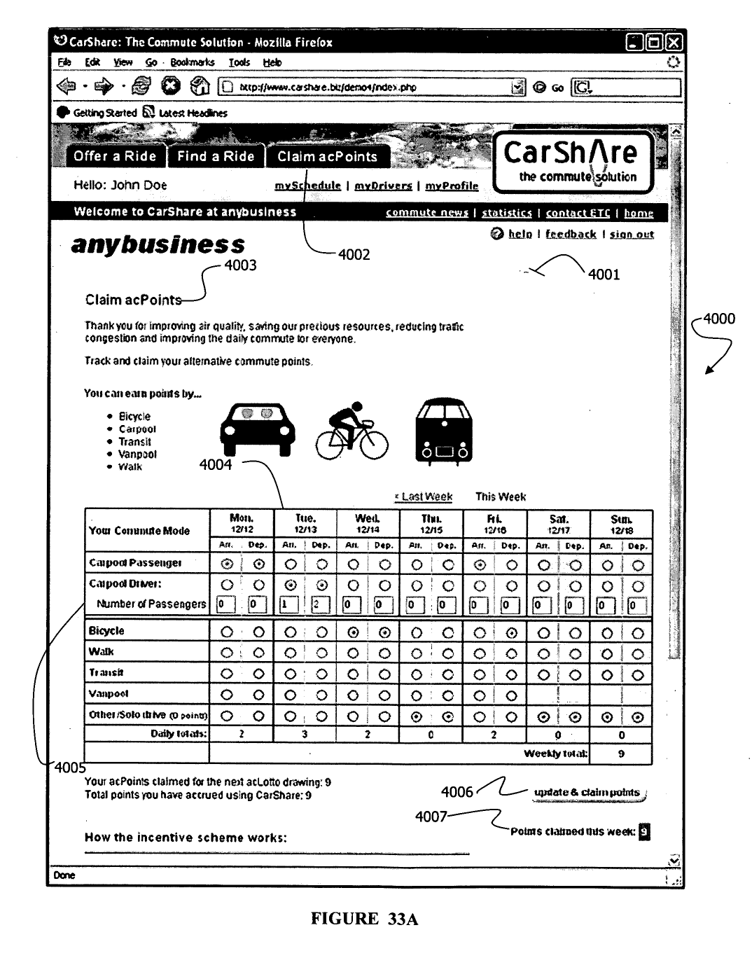

FIG. 32 is an exemplary screen 3900 illustrating a myProfile window 3901 according to some embodiments of the present invention. The myProfile window 3901 is accessed by clicking the myProfile link 3902. The page displays a myProfile area 3903 which allows the user to enter information about the user. The information entered may be saved or updated by clicking the save/update profile link 3905. The your acLotto Points area 3904 includes information about the user's alternative commute points earned by engaging in alternative commute activities. A remove your account link 3906 allows the user to remove their account from the system.

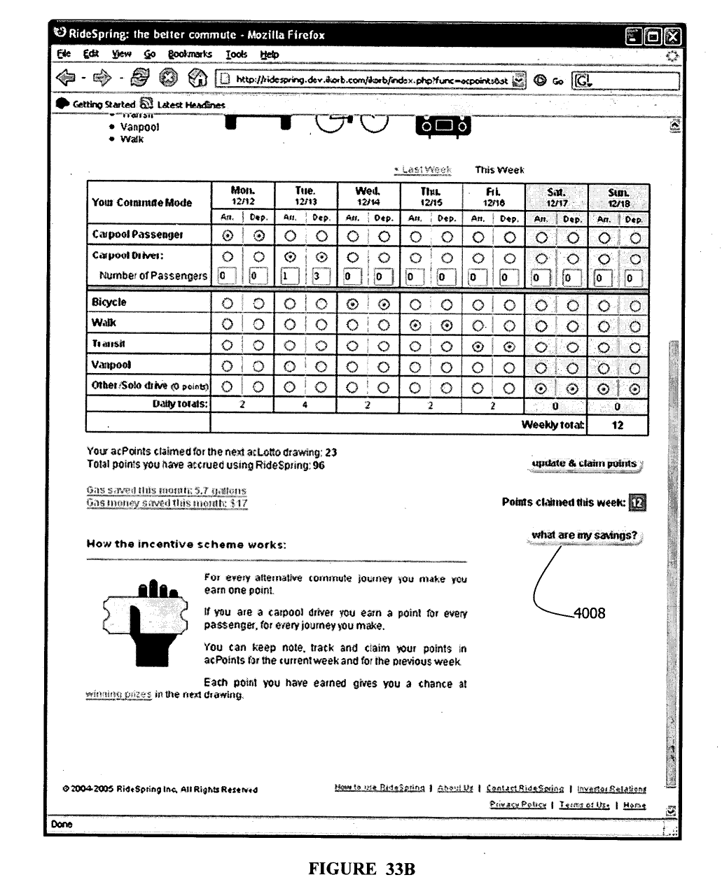

FIGS. 33A-B are the upper and lower portions of an exemplary screen 4000 illustrating a claim acPoints screen 4001 according to some embodiments of the present invention. The user enters in their alternative commuting activities 4005 into the matrix 4004, which then tallies points. Points may be updated and claimed by pressing a update & claim points link 4006. A tally of the points claimed this week is shown 4007. In this example, a user has a variety of ways to earn points based on alternative commuting activities, as seen. Activities other than carpooling earn the user points, such as bicycling and mass transit usage. A user may see their savings by clicking the what are my savings? link 4008. In some embodiments, the entry of points is an honor system, where the user is required to be honest about the points entered. This will function well in a group setting, though, as a user will be reluctant to be dishonest when using a system that involves co-worker and colleagues.

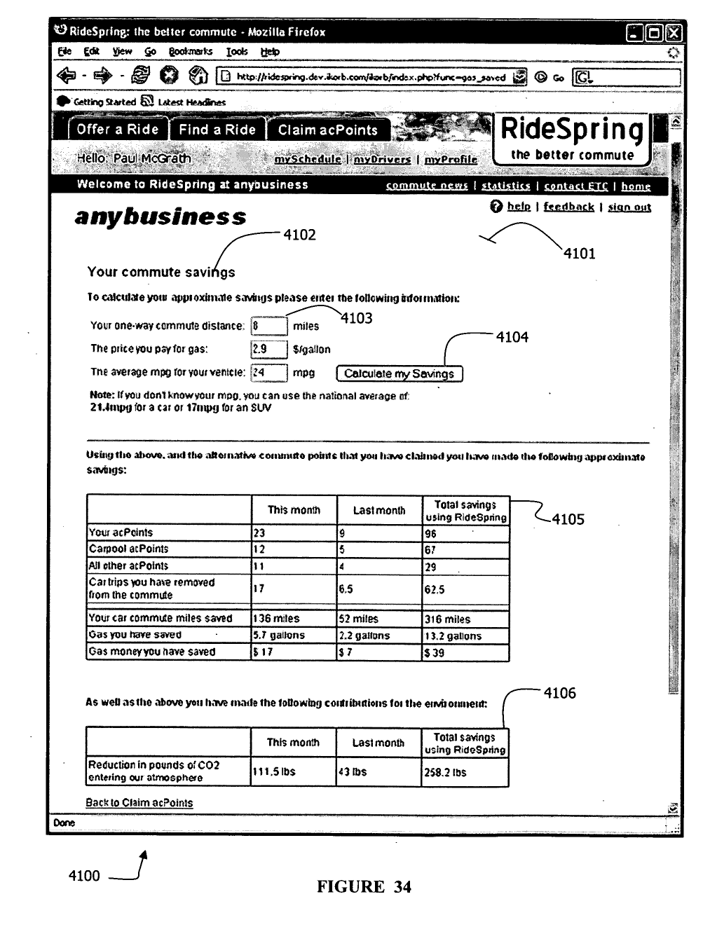

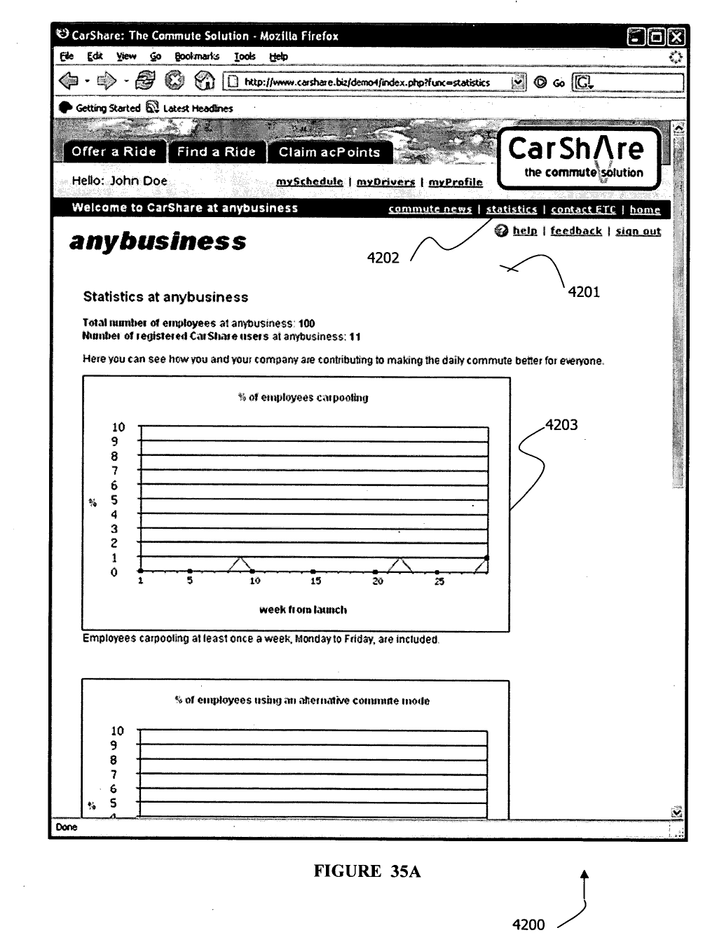

FIG. 34 is an exemplary screen 4100 illustrating a commute savings window 4101 according to some embodiments of the present invention. The commute savings window 4101 is accessed by clicking the what are my savings? link 4008. In the Your commute savings area 4102, the user enters information about their commute distance, the price they would pay for gas, and the average mpg of their vehicle in a set of boxes 4103. The user may then toggle the calculate my savings button 4104 to see their savings displayed. The user's alternative commute points and gas and monies saved are seen in one box 4105, and the amount of pollution reduction is seen in another box 4106.

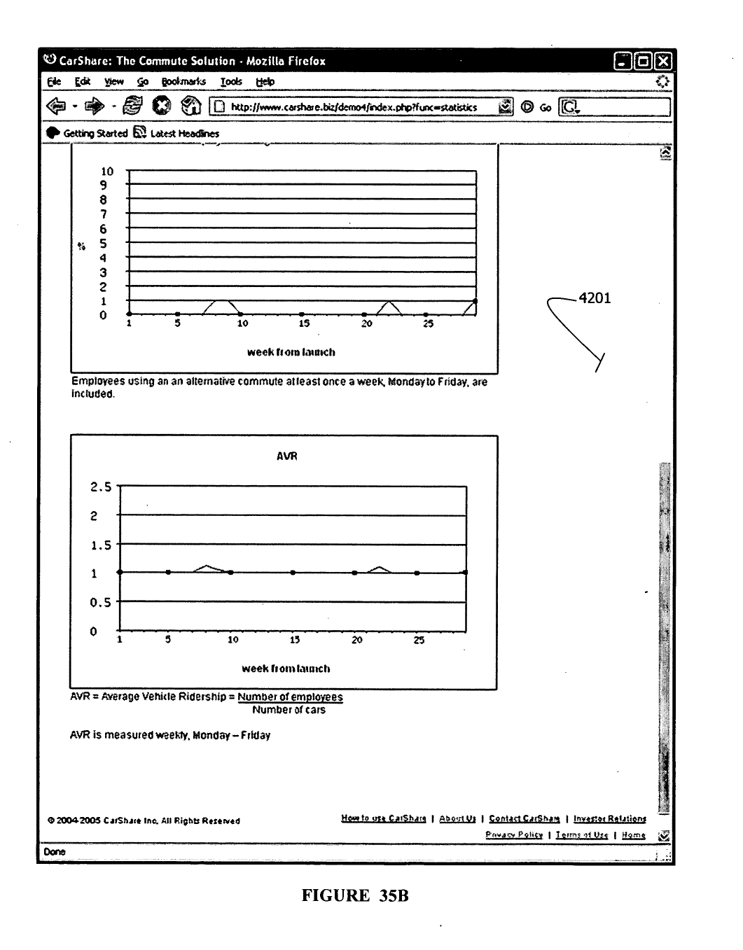

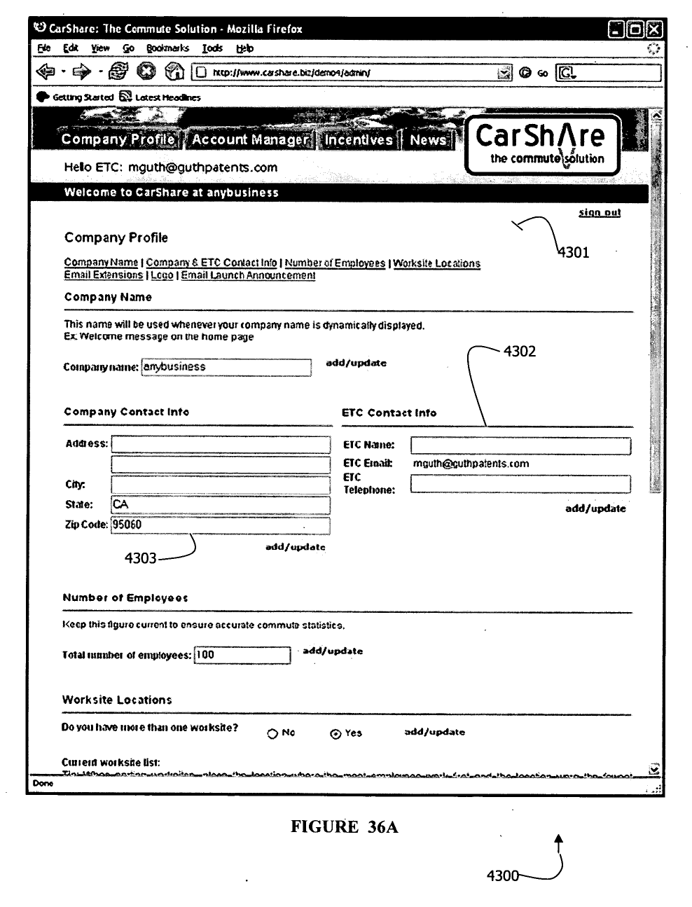

FIGS. 35A-B are the upper and lower portions of an exemplary screen 4200 illustrating a statistics window 4201 according to some embodiments of the present invention. The statistics window 4201 is accessed by clicking the what statistics link 4203. This page gives statistics regarding the percentage of the group that is carpooling 4203, the percentage of the group that is engaging in alternative commute modes, and the AVR. Displays such as these available to the members of the group will encourage more participation from within the group as the statistics foster a groupthink with regard to alternative commute activities.

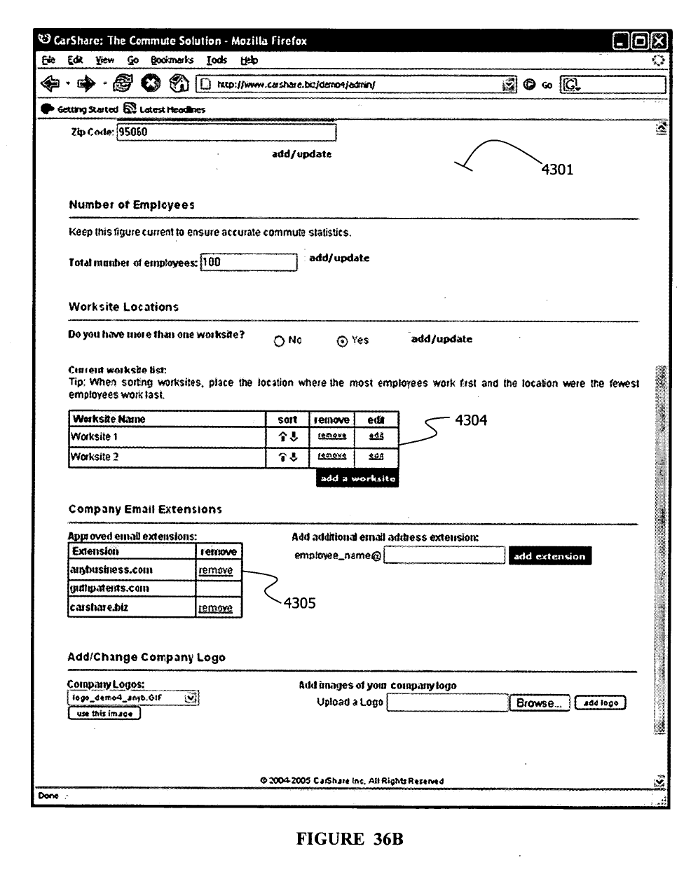

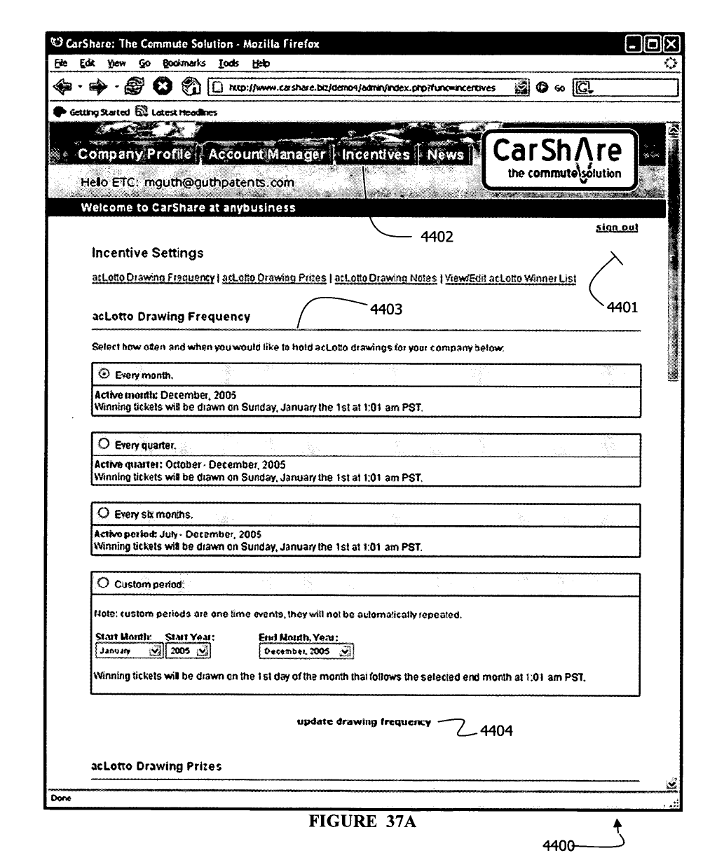

FIGS. 36A-B are the upper and lower portions of an exemplary screen 4300 illustrating a ETC window 4301 according to some embodiments of the present invention. The ETC window 4201 is accessed by the ETC when the ETC logs in to an administration page. This company profile page allows for the entry and editing of the ETC contact info 4302, the company contact info 4303, the worksites and names 4304, and the approved email extensions of the group 4305, and other functionalities as seen.

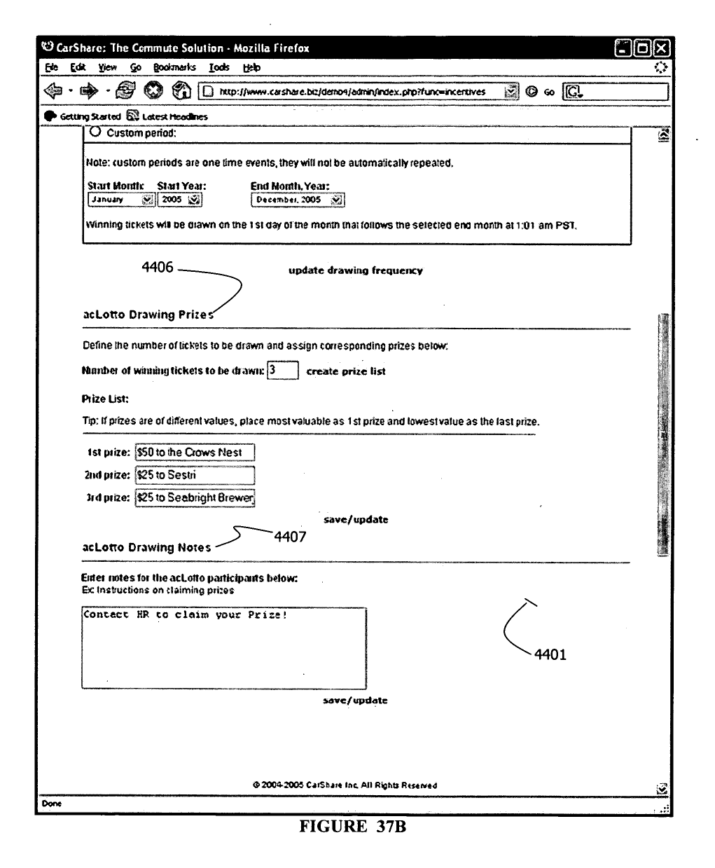

The ETC may also access and edit an Incentives page. FIGS. 37A-B are the upper and lower portions of an exemplary screen 4400 illustrating a ETC Incentives window 4401 according to some embodiments of the present invention. The ETC window 4401 is accessed by the ETC when the ETC clicks the Incentives link 4402. The ETC may set parameters for a prize-based lotto incentive scheme for users from that group. The ETC may set or edit the lotto drawing frequency 4403 and clicking the update link 4404. The ETC may also set information about the drawing prizes 4406. The ETC may also add notes that will be part of the information available to users 4407. The lotto may function as an inducement to users to increase their alternative commute activities. The acPoints claimed by a user during a given period may each function as a raffle ticket and allow the user the opportunity to increase the user's chances of winning a prize with more points claimed. Since acPoints are earned not just by carpooling but by other alternative commute modes such as bicycling and public transit, the system serves as an inducement to all types of alternative commute modes. By including all alternative commute modes, complete commute statistics are collected allowing a company to determine the complete commute patterns for the members of their group, company, or worksite. The will provided estimates of all car commute trips that have been saved, as well as the economic and environmental savings.

A prize based lotto system has multiple advantages. It generates news, for example who won what during the previous month, what the prizes will be in the future, etc. Also, in this scheme the cost of the scheme is contained and known in advance, as the number of prizes to be awarded may be fixed in advance. Such a scheme is very cost effective. Also, it may encourage alternative commuting even by persons not normally prone to try alternative commuting as just one alternative commute point will get a user into the lotto drawing.

It will be apparent to one with skill in the art that the methods and apparatus of the present invention may be practiced over the Internet using standard browser access methods from a variety of devices and locations. I will also be apparent to the skilled artisan that from the point of view of the network host, many smaller companies can be viewed and treated in the same manner as a single entity or coalition and may retain their own individual incentives and identities without departing from the spirit and scope of the invention. In other embodiment, the system of the present invention may be adapted to a large campus where there are many buildings, each one construed as an identified worksite within the system and wherein the employees are students rather than workers resident in any one worksite. In this case, the participating students may not only commute to and from the campus itself, but also may also offer and search for rides between the different worksites during the day. There are many possibilities.

The methods and apparatus of the present invention should be afforded the broadest possible interpretation under examination in light of the many embodiments described. The spirit and scope of the present invention should only be limited by the following claims.

What is claimed is:

1. A system for brokering commuter transactions initiated by individuals grouped by association and for populating individual commutes schedules and tallying incentive points earned by those individuals comprising:
a network server and data repository connected to a data network, the server including software for providing services to groups of individuals;
a plurality of network nodes having access to the network, the nodes operated by respective individuals of each group for the purpose of offering rides and for searching rides.

2. The system of claim 1, wherein the network is the Internet network.

3. The system of claim 1, wherein the server is a web server.

4. The system of claim 1, wherein the individuals are employees, groups of which define those employees of a company or business.

5. The system of claim 1, wherein the individuals are students, groups of which define students attending a university campus.

6. The system of claim 1, wherein the services are web services defined by web service description language.

7. The system of claim 6, wherein the web services include ride publishing, ride searching, transaction brokering, schedule population, statistics generation, and point tallying.

8. The system of claim 7 wherein said respective individuals of each group access said web services utilizing an internet home page specific to each group.

9. The system of claim 8 wherein said web services utilized by each group include ride publishing, ride searching, transaction brokering, schedule population, statistics generation, and point tallying involving only individuals specific to each group.

10. A software suite for brokering commuter transactions initiated by individuals grouped by association and for populating of individual commute schedules and tallying incentive points earned by those individuals comprising:
a first portion thereof for providing services to the individuals;
a second portion thereof for enabling definition and creation of those services; and
a third portion thereof for registering groups and for managing local parameters of groups registered.

11. The software suite of claim 10 practiced on the Internet network and on a sub-network connected to the Internet network.

12. The software suite of claim 10, wherein commuter transactions include acceptance and confirmation of a ride request submitted in response to an offered ride, the acceptance thereof a function of the software.

13. The software suite of claim 12 wherein an offered ride is limited in its offering to individuals within the same group as that of the offeror.

14. The software suite of claim 10, wherein commuter transactions include acceptance and confirmation of a ride request submitted in response to an offered ride, the acceptance thereof a function of the individual offering he ride.

15. The software suite of claim 14 wherein an offered ride is limited in its offering to individuals within the same group as that of the offeror.

16. The software suite of claim 10, wherein the individual commute schedules are automatically populated as a direct result of transactions recorded by the software.

17. The software suite of claim 10, wherein the incentive points are exchangeable for one or a combination of cash and discounts on third-party offered services or products.

18. The software suite of claim 10, wherein the first portion thereof has runtime access to one or more employee databases for the purpose of synchronization of data updated to those databases with the network database.

19. An electronic system for the managing commute information, said electronic system comprising:
a first computer system, said first computer system coupled to a global-area computer network, said first computer system executing instructions for implementing functionalities, said functionalities including:
receiving ride offers entered from members of a group via a global area computer network;
publishing ride offers received from members of a group to other members of that same group via a global-area computer network; and
receiving ride requests entered from members of a group in response to published ride offers from members of that same group via a global-area computer network.

20. The electronic system of claim 19 wherein said functionalities are implemented for a plurality of groups, wherein the members of said groups are limited to viewing information relative to members within their own group.

21. The electronic system of claim 19 wherein said first computer system further comprises instructions for automatically generating email to a first member of a group indicating that a ride request has been received from a second member of that same group in response to said first member's published ride offer.

22. The electronic system of claim 19, wherein said functionalities further include:
receiving commuting information from members of a group via a global-area computer network; and
compilation and publishing of commute statistics for a group, wherein the group's commute statistics are able to be viewed over a global-area computer network only by members of that group.

23. The electronic system of claim 22, wherein said functionalities further include:
calculating the savings realized by a member of a group based upon the received commuting information; and
publishing the savings calculated.

24. The electronic system of claim 20 wherein said functionalities further include:
receiving alternative commute mode information from members of a group via a global-area computer network;
calculating points for each member of a group based upon the received alternative commute mode information;
choosing winners of prizes using a lotto based system, wherein each member's probability of winning is based upon the number of points of that member.
